(19) United States
(12) Patent Application Publication
(10) Pub. No.: US 2006/0217970 A1
(43) Pub. Date: Sep. 28, 2006

(54) Method and apparatus for noise reduction

(75) Inventors: Rafid A. Sukkar, Aurora, IL (US); Richard C. Younce, Yokville, IL (US); Peng Zhang, Buffalo Grove, IL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Operations, Inc., Naperville, IL (US)

(21) Appl. No.: 11/159,843

(22) Filed: Jun. 22, 2005

Related U.S. Application Data
(60) Provisional application No. 60/665,910, filed on Mar. 28, 2005.
(60) Provisional application No. 60/665,911, filed on Mar. 28, 2005.

(51) Int. Cl. G10L 19/00

(52) U.S. Cl. 704/219

(57) ABSTRACT

Noise Reduction (NR) is performed directly in a coded domain. A Coded Domain Noise Reduction (CD-NR) system modifies at least one parameter of a first encoded signal, resulting in corresponding modified parameter(s). The CD-NR system replaces the parameter(s) of the first encoded signal with the modified parameter(s), resulting in a second encoded signal which, in a decoded state, approximates a target signal that is a function of the first encoded signal in at least a partially decoded state. Thus, the first encoded signal does not have to go through intermediate decode/re-encode processes, which can degrade overall speech quality. Computational resources required for a complete re-encoding are not needed. Overall delay of the system is minimized. The CD-NR system can be used in any network in which signals are communicated in a coded domain, such as a Third Generation (3G) wireless network.

### RELATED APPLICATION(S)

This application claims the benefit of U.S. Provisional Application No. 60/665,910 filed Mar. 28, 2005, entitled, “Method and Apparatus for Performing Echo Suppression in a Coded Domain,” and U.S. Provisional Application No. 60/665,911 filed Mar. 28, 2005, entitled, “Method and Apparatus for Performing Echo Suppression in a Coded Domain.” The entire teachings of these provisional applications are incorporated herein by reference.

### BACKGROUND OF THE INVENTION

Speech compression represents a basic operation of many telecommunications networks, including wireless and voice-over-Internet Protocol (VOIP) networks. This compression is typically based on a source model, such as Code Excited Linear Prediction (CELP). Speech is compressed at a transmitter based on the source model and then encoded to minimize valuable channel bandwidth that is required for transmission. In many newer generation networks, such as Third Generation (3G) wireless networks, the speech remains in a Coded Domain (CD) (i.e., compressed) even in a core network and is decompressed and converted back to a Linear Domain (LD) at a receiver. This compressed data transmission through a core network is in contrast with cases where the core network has to decompress the speech in order to perform its switching and transmission. This intermediate decompression introduces speech quality degradation. Therefore, new generation networks try to avoid decompression in the core network if both sides of the call are capable of compressing/decompressing the speech.

In many networks, especially wireless networks, a network operator (i.e., service provider) is motivated to offer a differentiating service that not only attracts customers, but also keeps existing ones. A major differentiating feature is voice quality. So, network operators are motivated to deploy in their network Voice Quality Enhancement (VQE). VQE includes: acoustic echo suppression, noise reduction, adaptive level control, and adaptive gain control.

Echo cancellation, for example, represents an important network VQE function. While wireless networks do not suffer from electronic (or hybrid) echoes, they do suffer from acoustic echoes due to an acoustic coupling between the ear-piece and microphone on an end user terminal. Therefore, acoustic echo suppression is useful in the network.

A second VQE function is a capability within the network to reduce any background noise that can be detected on a call. Network-based noise reduction is a useful and desirable feature for service providers to provide to customers because customers have grown accustomed to background noise reduction service.

A third VQE function is a capability within the network to adjust a level of the speech signal to a predetermined level that the network operator deems to be optimal for its subscribers. Therefore, network-based adaptive level control is a useful and desirable feature.

A fourth VQE function is adaptive gain control, which reduces listening effort on the part of a user and improves intelligibility by adjusting a level of the signal received by the user according to his or her background noise level. If the subscriber background noise is high, adaptive level control tries to increase the gain of the signal that is received by the subscriber.

In the older generation networks, where the core network decompresses a signal into the linear domain followed by conversion into a Pulse Code Modulation (PCM) format, such as A-law or μ-law, in order to perform switching and transmission, network-based VQE has access to the decompressed signals and can readily operate in the linear domain. (Note that A-law and μ-law are also forms of compression (i.e., encoding), but they fall into a category of waveform encoders. Relevant to VQE in a coded domain is source-model encoding, which is a basis of most low bit rate, speech coding.) However, when voice quality enhancement is performed in the network where the signals are compressed, there are basically two choices: a) decompress (i.e., decode) the signal, perform voice quality enhancement in the linear domain, and re-compress (i.e., re-encode) an output of the voice quality enhancement, or b) operate directly on the bit stream representing the compressed signal and modify it directly to effectively perform voice quality enhancement. The advantages of choice (b) over choice (a) are three fold:

First, the signal does not have to go through an intermediate decode/re-encode, which can degrade overall speech quality. Second, since computational resources required for encoding are relatively high, avoiding another encoding step significantly reduces the computational resources needed. Third, since encoding adds significant delays, the overall delay of the system can be minimized by avoiding an additional encoding step.

Performing VQE functions or combinations thereof in the compressed (or coded) domain, however, represents a more challenging task than VQE in the decompressed (or linear) domain.

### SUMMARY OF THE INVENTION

A method or corresponding apparatus in an exemplary embodiment of the present invention performs Coded Domain Noise Reduction (CD-NR) on a first encoded signal by first modifying at least one parameter of the first encoded signal, which results in a corresponding at least one modified parameter. The method and corresponding apparatus then replaces the at least one parameter of the first encoded signal with the at least one modified parameter, which results in a second encoded signal. In a decoded state, the second encoded signal approximates a target signal that is a function of the first encoded signal in at least a partially decoded state.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a network diagram of a network in which a system performing Coded Domain Voice Quality Enhancement (CD-VQE) using an exemplary embodiment of the present invention is deployed;

FIG. 2 is a high level view of the CD-VQE system of FIG. 1;

FIG. 3A is a detailed block diagram of the CD-VQE system of FIG. 1;

FIG. 3B is a flow diagram corresponding to the CD-VQE system of FIG. 3A;

FIG. 4 is a network diagram in which the CD-VQE processor of FIG. 1 is performing Coded Domain Acoustic Echo Suppression (CD-AES);

FIG. 5 is a block diagram of a CELP synthesizer used in the coded domain embodiments of FIGS. 1 and 4 and other coded domain embodiments;

FIG. 6 is a high level block diagram of the CD-AES system of FIG. 4;

FIG. 7A is a detailed block diagram of the CD-AES system of FIG. 4;

FIG. 7B is a flow diagram corresponding to the CD-AES system of FIG. 7A;

FIG. 8 is a plot of a decoded speech signal processed by the CD-AES system of FIG. 4;

FIG. 9 is a plot of an energy contour of the speech signal of FIG. 8;

FIG. 10 is a plot of a synthesis LPC excitation energy scale ratio corresponding to the energy contour of FIG. 9;

FIG. 11 is a plot of a decoded speech energy contour resulting from Joint Codebook Scaling (JCS) used in the CD-AES system of FIG. 7A;

FIG. 12 is a plot of a decoded speech energy contour for fixed codebook scaling shown for comparison purposes to FIG. 11;

FIG. 13A is a detailed block diagram corresponding to the CD-AES system of FIG. 7A further including Spectrally Matched Noise Injection (SMNI);

FIG. 13B is a flow diagram corresponding to the CD-AES system of FIG. 13A;

FIG. 14 is a network diagram including a Coded Domain Noise Reduction (CD-NR) system optionally included in the CD-VQE system of FIG. 1;

FIG. 15 is a high level block diagram of the CD-NR system of FIG. 14;

FIG. 16A is a detailed block diagram of the CD-NR system of FIG. 15 using a first method;

FIG. 16B is a flow diagram corresponding to the CD-NR system of FIG. 16A;

FIG. 17A is a detailed block diagram of the CD-NR system of FIG. 15 using a second method.

FIG. 17B is a flow diagram corresponding to the CD-NR system of FIG. 17A;

FIG. 18 is a block diagram of a network employing a Coded Domain Adaptive Level Control (CD-ALC) optionally provided in the CD-VQE system of FIG. 1;

FIG. 19 is a high level block diagram of the CD-ALC system of FIG. 18;

FIG. 20A is a detailed block diagram of the CD-ALC system of FIG. 19;

FIG. 20B is a flow diagram corresponding to the CD-ALC system of FIG. 20A;

FIG. 21 is a network diagram using a Coded Domain Adaptive Gain Control (CD-AGC) system optionally used in the CD-VQE system of FIG. 1;

FIG. 22 is a high level block diagram of the CD-AGC system of FIG. 21;

FIG. 23A is detailed block diagram of the CD-AGC system of FIG. 22;

FIG. 23B is a flow diagram corresponding to the CD-AGC system of FIG. 23A; and

FIG. 24 is a network diagram of a network including Second Generation (2G), Third Generation (3G) networks, VOIP networks, and the CD-VQE system of FIG. 1, or subsets thereof, distributed about the network.

### DETAILED DESCRIPTION OF THE INVENTION

A description of preferred embodiments of the invention follows.

Coded Domain Voice Quality Enhancement

A method and corresponding apparatus for performing Voice Quality Enhancement (VQE) directly in the coded domain using an exemplary embodiment of the present invention is presented below. As should become clear, no intermediate decoding/re-encoding is performed, thereby avoiding speech degradation due to tandem encodings and also avoiding significant additional delays.

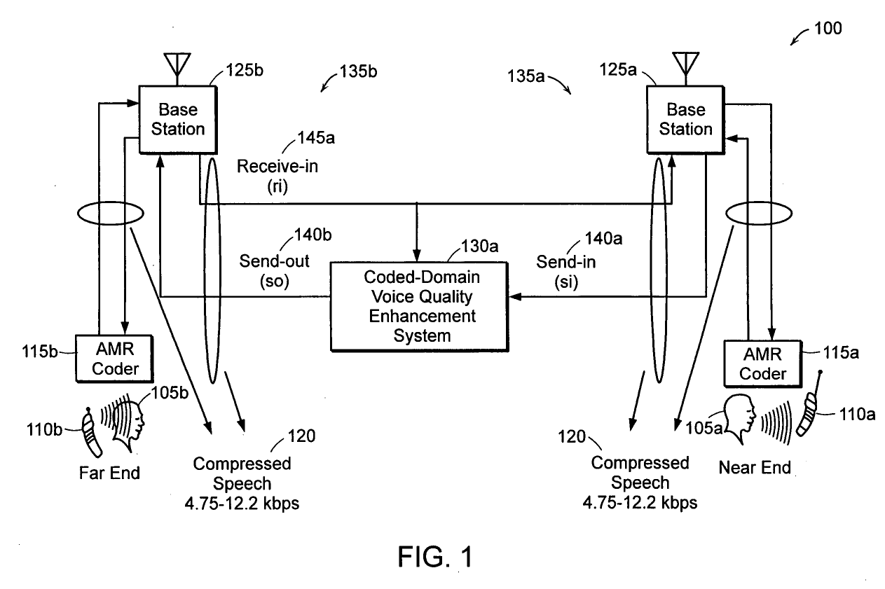

FIG. 1 is a block diagram of a network 100 including a Coded Domain VQE (CD-VQE) system 130a. For simplicity, the CD-VQE system 130a is shown on only one side of a call with an understanding that CD-VQE can be performed on both sides. The one side of the call is referred to herein as the near end 135a, and the other side of the call is referred to herein as the far end 135b.

In FIG. 1, the CD-VQE system 130a is performed on a send-in signal (si) 140a generated by a near end user 105a using a near end wireless telephone 110a. A far end user 105b using a far end telephone 110b communicates with the near end user 105a via the network 100. A near end Adaptive Multi-Rate (AMR) coder 115a and a far end AMR coder 115b are employed to perform encoding/decoding in the telephones 115a, 115b. A near end base station 125a and a far end base station 125b support wireless communications for the telephones 110a, 110b, including passing through compressed speech 120. Another example includes a network 100 in which the near end wireless telephone 110a may also be in communication with a base station 125a, which is connected to a media gateway (not shown), which in turn communicates with a conventional wireline telephone or Public Switched Telephone Network (PSTN).

In FIG. 1, a receive-in signal, ri, 145a, send-in signal, si, 140a, and send-out signal, so, 140b are bit streams representing the compressed speech 120. Focus herein is on the CD-VQE system 130a operating on the send-in signal, si, 140a.

The CD-VQE method and corresponding apparatus disclosed herein is, by way of example, directed to a family of speech coders based on Code Excited Linear Prediction (CELP). According to an exemplary embodiment of the present invention, an Adaptive Multi-Rate (AMR) set of coders is considered an example of CELP coders. However, the method for the CD-VQE disclosed herein is directly applicable to all coders based on CELP. Coders based on CELP can be found in both mobile phones (i.e., wireless phones) as well as wireline phones operating, for example, in a Voice-over-Internet Protocol (VOIP) network. Therefore, the method for CD-VQE disclosed herein is directly applicable to both wireless and wireline communications.

Typically, a CELP-based speech encoder, such as the AMR family of coders, segments a speech signal into frames of 20 msec. in duration. Further segmentation into subframes of 5 msec. may be performed, and then a set of parameters may be computed, quantized, and transmitted to a receiver (i.e., decoder). If m denotes a subframe index, a synthesizer (decoder) transfer function is given by

$${D}_{m} ( z ) = \frac{S ( z )}{{C}_{m} ( z )} = \frac{{g}_{c} ( m )}{[ 1 - {g}_{p} ( m ) {z}^{- T ( m )} ] [ 1 - {\sum }_{i = 1}^{p} {a}_{i} ( m ) {z}^{- i} ]} \qquad ( 1 )$$

where S(z) is a z-transform of the decoded speech, and the following parameters are the coded-parameters that are computed, quantized, and sent by the encoder:

g_{c}(m) is the fixed codebook gain for subframe m,

gₚ(m) is the adaptive codebook gain for subframe m,

T(m) is the pitch value for subframe m,

{aᵢ(m)} is the set of P linear predictive coding parameters for subframe m, and

Cₘ(z) is the z-transform of the fixed codebook vector, cₘ(n), for subframe m.

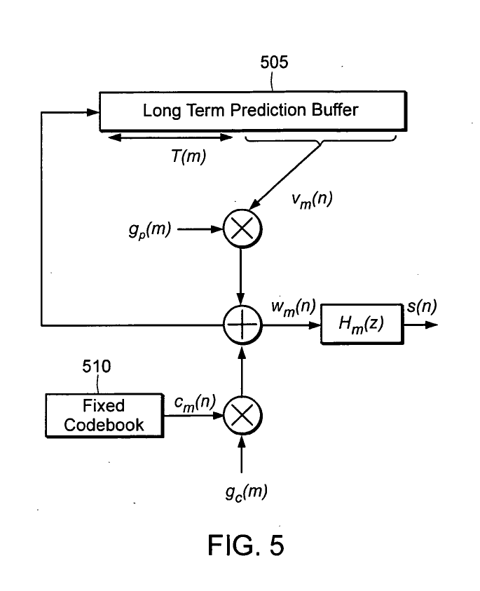

FIG. 5 is a block diagram of a synthesizer used to perform the above synthesis. The synthesizer includes a long term prediction buffer 505, used for an adaptive codebook, and a fixed codebook 510, where

vₘ(n) is the adaptive codebook vector for subframe m,

wₘ(n) is the Linear Predictive Coding (LPC) excitation signal for subframe m, and

Hₘ(z) is the LPC filter for subframe m, given by

$${H}_{m} ( z ) = \frac{1}{1 - {\sum }_{i = 1}^{p} {a}_{i} ( m ) {z}^{- i}} \qquad ( 2 )$$

Based on the above equation, one can write
s(n)=wₘ(n)*hₘ(n) (3)

where hₘ(m) is the impulse response of the LPC filter, and
wₘ(n)=gₚ(m)vₘ(n)+g_{c}(m)cₘ(n) (4)

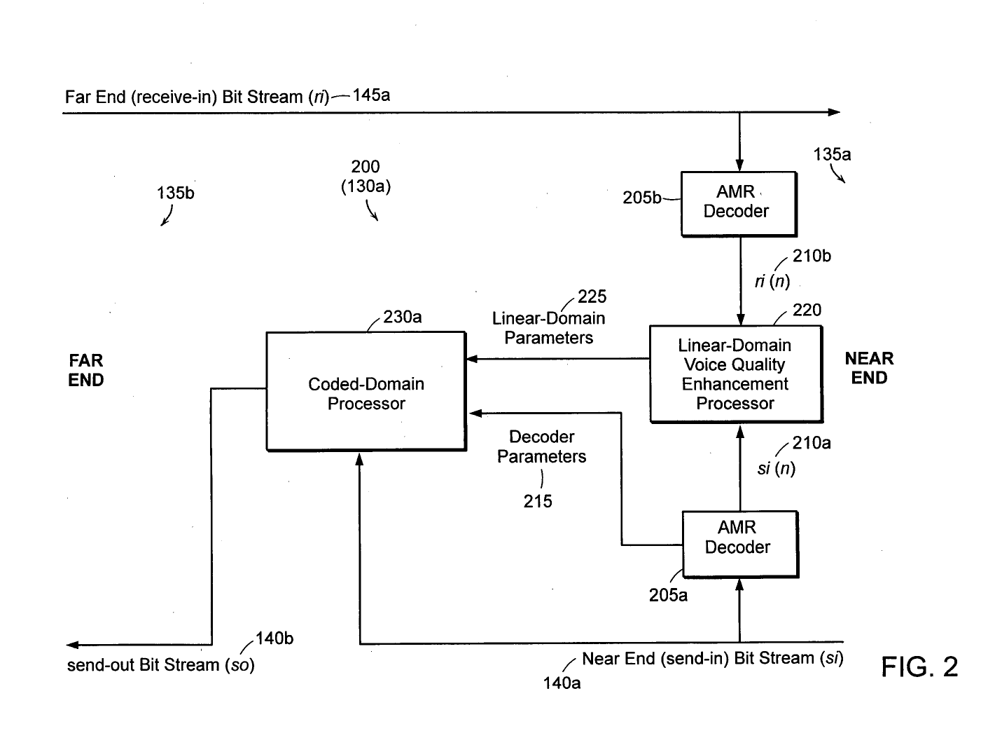

FIG. 2 is a block diagram of an exemplary embodiment of a CD-VQE system 200 that can be used to implement the CD-VQE system 130a introduced in FIG. 1. A Coded Domain VQE method and corresponding apparatus are described herein whose performance matches the performance of a corresponding Linear-Domain VQE technique. To accomplish this matching performance, after performing Linear-Domain VQE (LD-VQE), the CD-VQE system 200 extracts relevant information from the LD-VQE. This information is then passed to a Coded Domain VQE.

Specifically, FIG. 2 is a high level block diagram of the approach taken. In this figure, only the near-end side 135a of the call is shown, where VQE is performed on the send-in bit stream, si, 140a. The send-in and receive-in bit streams 140a, 145a are decoded by AMR decoders 205a, 205b (collectively 205) into the linear domain, si(n) and ri(n) signals 210a, 210b, respectively, and then passed through a linear domain VQE system 220 to enhance the si(n) signal 210a. The LD-VQE system 220 can include one or more of the functions listed above (i.e., acoustic echo suppression, noise reduction, adaptive level control, or adaptive gain control). Relevant information is extracted from both the LD-VQE 220 and the AMR decoder 205, and then passed to a coded domain processing unit 230a. The coded domain processing unit 230a modifies the appropriate parameters in the si bit stream 140a to effectively perform VQE.

It should be understood that the AMR decoding 205 can be a partial decoding of the two signals 140a, 145a. For example, since most LD-VQE systems 220 are typically concerned with determining signal levels or noise levels, a post-filter (not shown) present in the AMR decoders 205 need not be implemented. It should further be understood that, although the si signal 140a is decoded into the linear domain, there is no intermediate decoding/re-encoding that can degrade the speech quality. Rather, the decoded signal 210a is used to extract relevant information 215, 225 that aids the coded domain processor 230a and is not re-encoded after the LD-VQE processor 220.

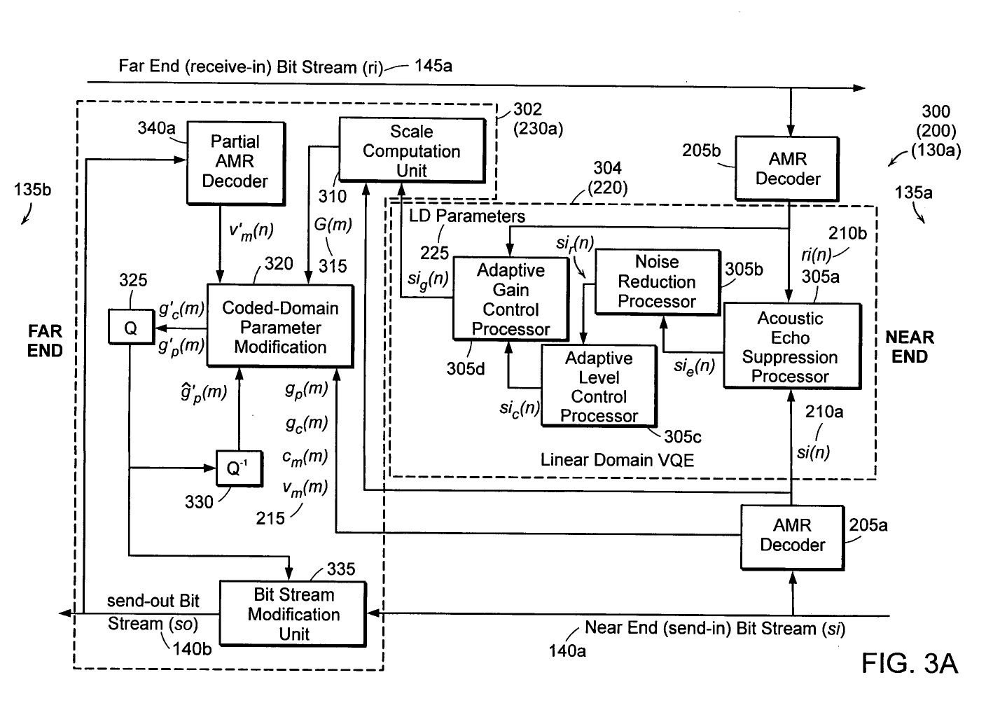

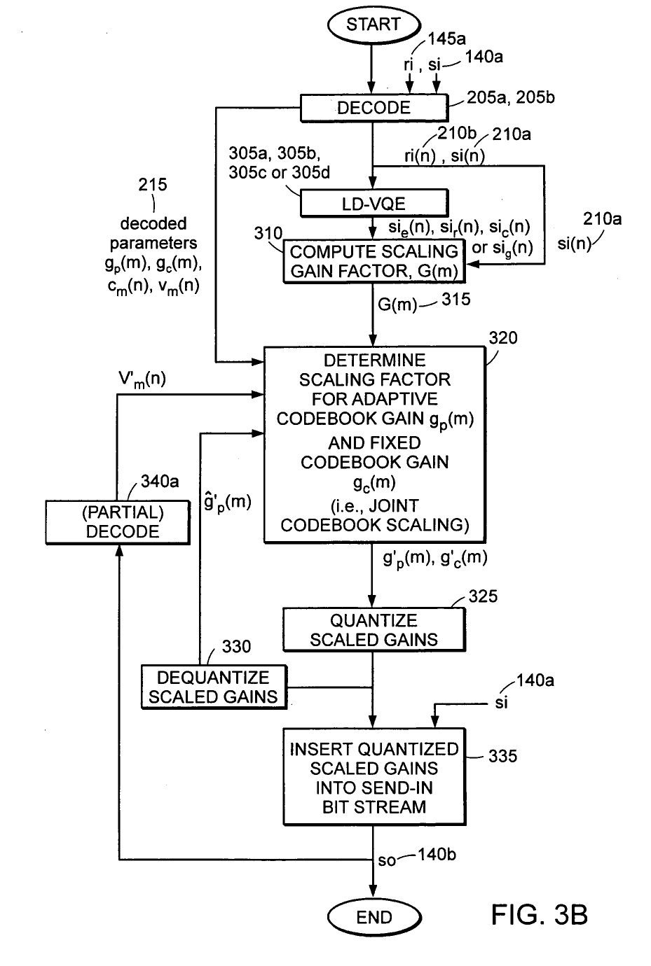

FIG. 3A is a block diagram of an exemplary embodiment of a CD-VQE system 300 that can be used to implement the CD-VQE systems 130a, 200. In this embodiment, an exemplary embodiment of a LD-VQE system 304, used to implement the LD-VQE system 220 of FIG. 2, includes four processors 305a, 305b, 305c, and 305d of LD-VQE, But, in general, any number of LD-VQE processors 305a-d can be cascaded in exemplary embodiments of the present invention. In exemplary embodiments of the present invention, the problem(s) of VQE in the coded domain are transformed from the processor(s) themselves to one of scaling the signal 140a on a segment-by-segment basis.

An exemplary embodiment of a coded domain processor 302 can be used to implement the coded domain processor 230a introduced in reference to FIG. 2. In the coded domain processor 302 of FIG. 3, a scaling factor G(m) 315 for a given segment is determined by a scale computation unit 310 that computes power or level ratios between the output signal of the LD-VQE 304 and the linear domain signal si(n) 210a. A “Coded Domain Parameter Modification” unit 320 in FIG. 3A employs a Joint Codebook Scaling (JCS) method. In JCS, both a CELP adaptive codebook gain, gₚ(m), and a fixed codebook gain, g_{c}(m), are scaled, and the JCS outputs are the scaled gains, g′ₚ(m) and g′_{c}(m). They are then quantized by a quantizer 325 and inserted by a bit stream modification unit 335, also referred to herein as a replacing unit 335, in the send-out bit stream, so, 140b, replacing the original gain parameters present in the si bit stream 140a. These scaled gain parameters, when used along with the other coder parameters 215 in the AMR decoder 205a, produce a signal 140b that is an enhanced version of the original signal, si(n), 210a.

A dequantizer 330 feeds back dequantized forms of the quantized, adaptive codebook, scaled gain to the Coded Domain Parameter Modification unit 320. Note that decoding the signal ri 145a into ri(n) 210b is used if one or more of the VQE processors 305a-d accesses ri(n) 210b. These processors include acoustic echo suppression 305a and adaptive gain control 305d. If VQE does not require access to ri(n) 210b, then decoding of ri 145a can be removed from FIGS. 2 and 3A.

The operations in the CD-VQE system 300 shown in FIG. 3A are summarized, and presented in the form of a flow diagram in FIG. 3B, immediately below:

(i) The receive input signal bit stream ri 145a is decoded into the linear domain signal, ri(n), 210b if required by the LD-VQE processors 305a-d, specifically acoustic echo suppression 305a and adaptive gain control 305d.

(ii) The send-in bit stream signal si 140a is decoded into the linear domain signal, si(n) 210a.

(iii) When more than one of the Linear Domain VQE processors 305a-d are used, the Linear-Domain VQE processors 305a-d may be interconnected serially, where an input to one processor is the output of the previous processor. The linear domain signal si(n) 210a is an input to the first processor (e.g., acoustic echo suppression 305a), and the linear domain signal ri(n) 210b is a potential input to any of the processors 305a-d. The LD-VQE output signal 225 and the linear domain send-in signal si(n) 210a are used to compute a scaling factor G(m) 315 on a frame-by-frame basis, where m is the frame index. A frame duration of a scale computation is equal to a subframe duration of the CELP coder. For example, in an AMR 12.2 kbps coder, the subframe duration is 5 msec. The scale computation frame duration is therefore set to 5 msec.

(iv) The scaling factor, G(m), is used to determine a scaling factor for both the adaptive codebook gain gₚ(m) and the fixed codebook gain and g_{c}(m) parameters of the coder. The Coded-Domain Parameter Modification unit 320 employs Joint Codebook Scaling to scale gₚ(m) and g_{c}(m).

(v) The scaled gains g′ₚ(m) and g′_{c}(m) are quantized 325 and inserted 335 into the send-out bit stream, so, 140b by substituting the original quantized gains in the si bit stream 140a.

Coded Domain Echo Suppression

A framework and corresponding method and apparatus for performing acoustic echo suppression directly in the coded domain using an exemplary embodiment of the present invention is now described. As described above in reference to VQE, for acoustic echo suppression performed directly in the coded domain, no intermediate decoding/re-encoding is performed, which avoids speech degradation due to tandem encodings and also avoids significant additional delays.

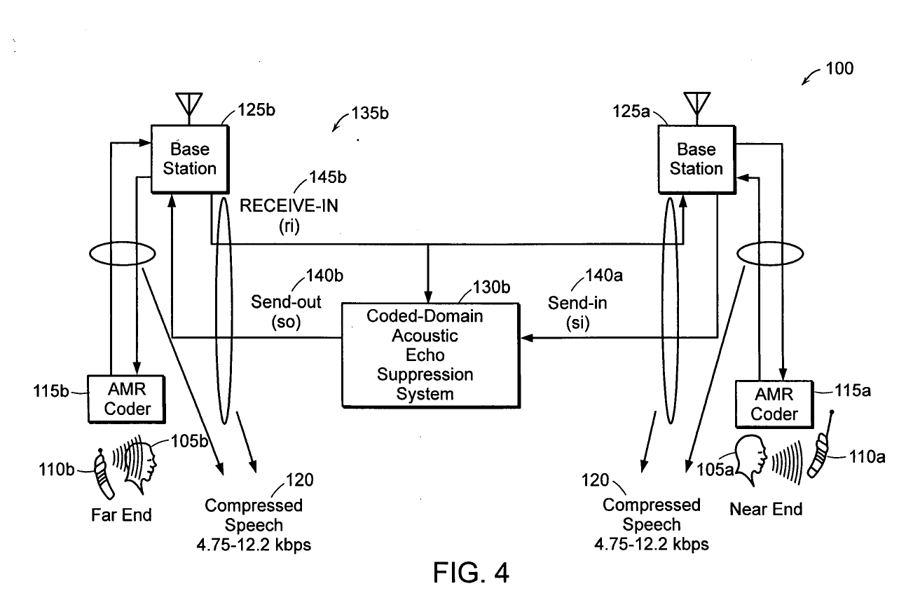

FIG. 4 is a block diagram of a network 100 using a Coded Domain Acoustic Echo Suppression (CD-AES) system 130b. In FIG. 4, the receive-in signal, ri, 145a, the send-in signal, si, 140a, and the send-out signal, so, 140b are bit streams representing compressed speech 120.

The CD-AES method and corresponding apparatus 130b is applicable to a family of speech coders based on Code Excited Linear Prediction (CELP). According to an exemplary embodiment of the present invention, the AMR set of coders 115 are considered an example of CELP coders. However, the method for CD-AES presented herein is directly applicable to all coders based on CELP

The Coded Domain Echo suppression method and corresponding apparatus 130b meets or exceeds the performance of a corresponding Linear Domain-Echo Suppression technique. To accomplish such performance, a Linear-Domain Echo Acoustic Suppression (LD-AES) unit 305a is used to provide relevant information, such as decoder parameters 215 and linear-domain parameters 225. This information 215, 225 is then passed to a coded domain processing unit 230b.

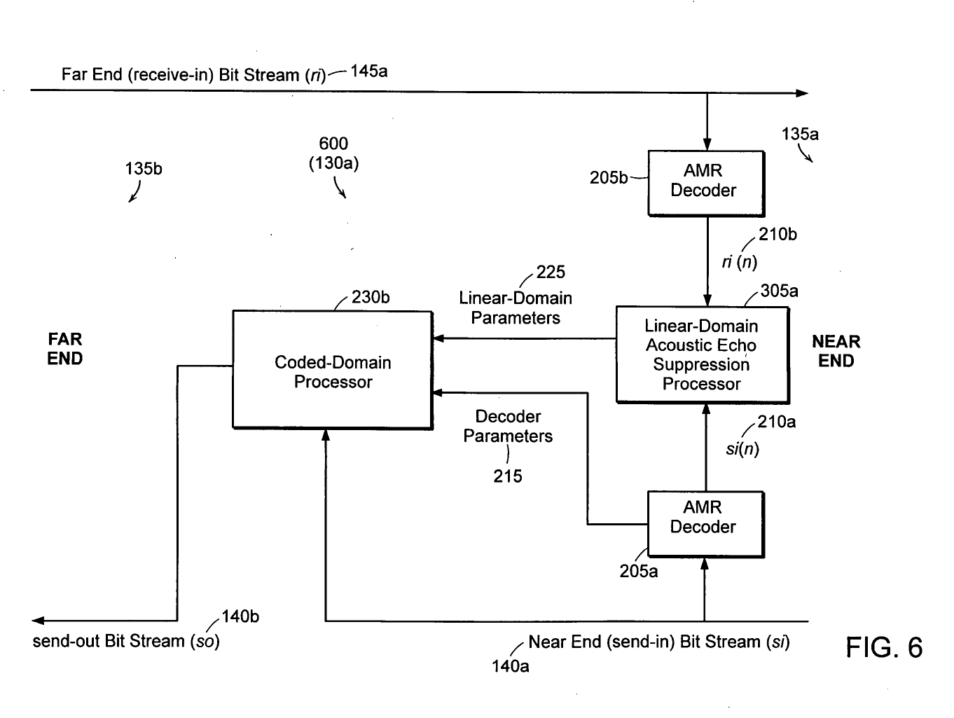

FIG. 6 is a high level block diagram of an approach used for performing Coded Domain Acoustic Echo Suppression (CD-AES), or Coded Domain Echo Suppression (CD-ES) when the source of the echo is other than acoustic. An exemplary CD-AES system 600 can be used to implement the CD-AES system 130b of FIG. 4. In FIG. 6, both the ri and si bit streams 145a, 140a are decoded into the linear domain signals, ri(n) 210b and si(n) 210a, respectively. They are then passed through a conventional LD-AES processor 305a to suppress possible echoes in the si(n) signal 210a. Relevant information is extracted from both LD-AES and the AMR decoding processes 305a and 205a, respectively, and then passed to the coded domain processor 230b. The coded domain processor 230b modifies appropriate parameters in the si bit stream 140a to effectively suppress possible echoes in the signal 140a.

It should be understood that the AMR decoding 205 can be a partial decoding of the two signals 140a, 145a. For example, since the LD-AES processor 305a is typically based on signal levels, the post-filter present in the AMR decoders 205 need not be implemented since it does not affect the overall level of the decoded signal. It should further be understood that, although the si signal 140a is decoded into the linear domain, there is no intermediate decoding/re-encoding that can degrade the speech quality. Rather, the decoded signal 210a is used to extract relevant information that aids the coded domain processor 230b and is not re-encoded after the LD-AES processor 305a.

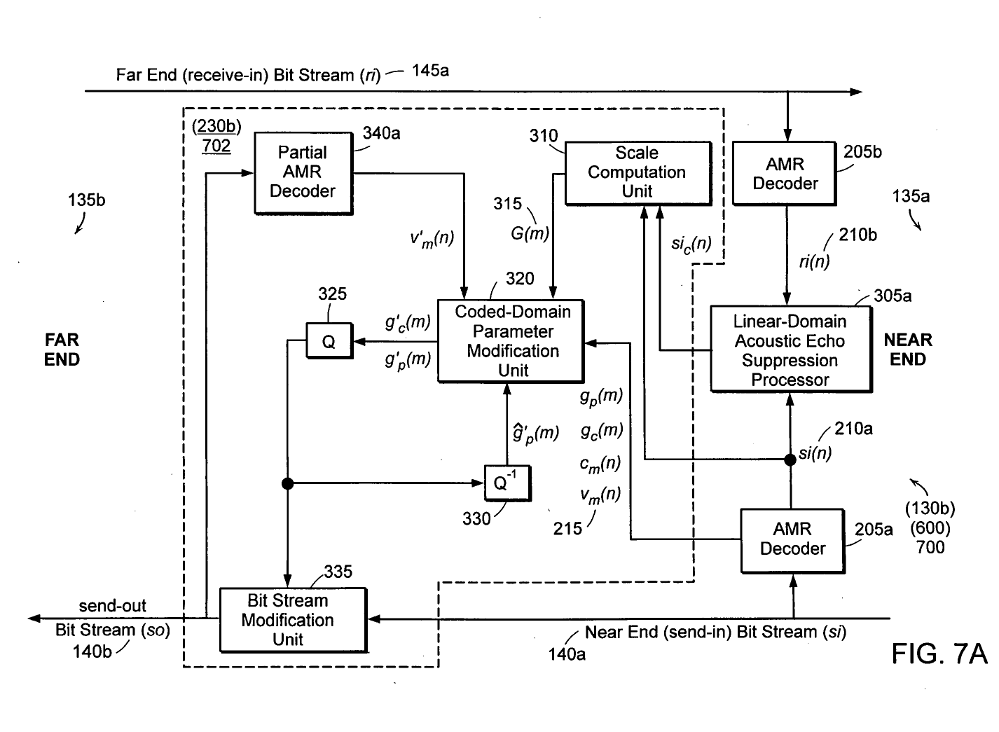

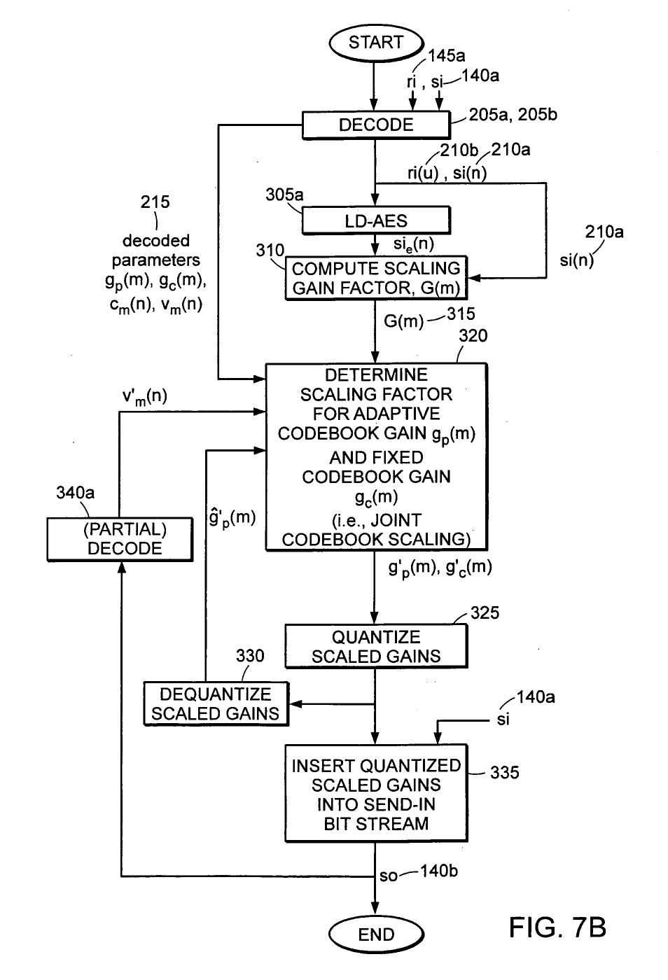

FIG. 7A is a detailed block diagram of an exemplary embodiment of a CD-AES system 700 that can be used to implement the CD-AES systems 130b, 600 of FIGS. 4 and 6. Given the fact that the outcome of a conventional LD-AES system 305a is to adaptively scale the linear domain signal si(n) 210a so as to suppress any possible echoes and pass through any near end speech, the coded domain echo suppression unit 700 operates as follows: it modifies the bit stream, si, 140a so that the resulting bit stream, so, 140b when decoded, results in a signal, so(n), 210a that is as close as possible to the linear domain echo-suppressed signal, siₑ(n), also referenced to herein as a target signal. Therefore, since siₑ(n) is typically a scaled version of si(n) 210a, the problem of the coded domain echo suppression is transformed to a problem of how properly to modify a given encoded signal bit stream to result, when decoded, in an adaptively scaled version of the signal corresponding to the original bit stream. The scaling factor G(m) 315 is determined by the scale computation unit 310 by comparing the energy of the signal si(n) 210a to the energy of the echo suppressed signal siₑ(n).

Before addressing the coded domain scaling problem, a summary of the operations in the CD-AES system 700 shown in FIG. 7A is presented in the form of a flow diagram in FIG. 7B:

(i) The bit streams ri 145a and si 140a are decoded 205a, 205b into linear signals, ri(n) 210b and si(n) 210a.

(ii) A Linear-Domain Acoustic Echo Suppression processor 305a that operates on ri(n) 210b and si(n) 210a is performed. The LD-AES processor 305a output is the signal siₑ(n), which represents the linear domain send-in signal, si(n), 210a after echoes have been suppressed.

(iii) A scale computation unit 310 determines the scaling factor G(m) 315 between si(n) 210a and siₑ(n). A single scaling factor, G(m), 315 is computed for every frame (or subframe) by buffering a frame worth of samples of si(n) 210a and siₑ(n) and determining a ratio between them. One possible method for computing G(m) 315 is a simple power ratio between the two signals in a given frame. Other methods include computing a ratio of the absolute value of every sample of the two signals in a frame, and then taking a median, or average of the sample ratio for the frame, and assigning the result to G(m) 315. The scaling factor 315 can be viewed as the factor by which a given frame of si(n) 210a has to be scaled by to suppress possible echoes in the coded domain signal 140a. The frame duration of the scale computation is equal to the subframe duration of the CELP coder. For example, in the AMR 12.2 bps coder, the subframe duration is 5 msec. The scale computation frame duration is therefore set to 5 msec. also.

(iv) The scaling factor, G(m), 315 is used to determine 320 a scaling factor for both the adaptive codebook gain gₚ(m) and the fixed codebook gain parameters g_{c}(m) of the coder. The Coded-Domain Parameter Modification unit 320 employs the Joint Codebook Scaling method to scale gₚ(m) and g_{c}(m).

(v) The scaled gains gₚ(m) and g_{c}(m) are quantized 325 and inserted 335 into the send-out bit stream, so, 140b by substituting the original quantized gains in the si bit stream 140a.

Signal Scaling in the Coded Domain

The problem of scaling the speech signal 140a by modifying its coded parameters directly has applications not only in Acoustic Echo Suppression, as described immediately above, but also in applications such as Noise Reduction, Adaptive Level Control, and Adaptive Gain Control, as are described below. Equation (1) above suggests that, by scaling the fixed codebook gain, g_{c}(m), by a given factor, G, a corresponding speech signal, which is also scaled by G, can be determined directly. However, this is true if the synthesis transfer function, Dₘ(z), is time-invariant. But, it is clear that Dₘ(z) is a function of the subframe index, m, and, therefore, is not time-invariant.

Previous coded domain scaling methods that have been proposed modify the fixed codebook gain, g_{c}(m). See C. Beaugeant, N. Duetsch, and H. Taddei, “Gain Loss Control Based on Speech Codec Parameters,” in Proc. European Signal Processing Conference, pp. 409-412, September 2004. Other methods, such as proposed by R. Chandran and D. J. Marchok, “Compressed Domain Noise Reduction and Echo Suppression for Network Speech Enhancement,” in Proc. 43^{rd} IEEE Midwest Symp. on Circuits and Systems, pp. 10-13, August 2000, try to adjust both gains based on some knowledge of the nature of the given speech segment or subframe (e.g., voiced vs. unvoiced).

In contrast, exemplary embodiments of the present invention do not require knowledge of the nature of the speech subframe. It is assumed that the scaling factor, G(m), 315 is calculated and used to scale the linear domain speech subframe. This scaling factor 315 can come from, for example, a linear-domain processor, such as acoustic echo suppression processor, as discussed above. Therefore, given G(m) 315, an analytical solution jointly scales both the adaptive codebook gain, gₚ(m), and the fixed codebook gain, g_{c}(m), such that the resulting coded parameters, when decoded, result in a properly scaled linear domain signal. This joint scaling, described in detail below, is based on preserving a scaled energy of an adaptive portion of the excitation signal, as well as a scaled energy of the speech signal. This method is referred to herein as Joint Codebook Scaling (JCS).

The Coded Domain Parameter Modification unit 320 in FIG. 7A executes JCS. It has the inputs listed below. For simplicity and without loss of generality, the subframe index, m, is dropped with the understanding that the processing units can operate on a subframe-by-subframe basis.

(i) The gain, G, is to be applied for a given subframe as determined by the scale computation unit 310 following the LD-AES processor 305a.

(ii) The adaptive and fixed codebook vectors, v(n) and c(n), respectively, correspond to the original unmodified bit stream, si, 140a. These vectors are already determined in the decoder 205a that produces si(n), 210a, as FIG. 7A shows. Therefore, they are readily available to the JCS processor 320.

(iii) The adaptive and fixed codebook gains, gₚ and g_{c}, respectively, correspond to the original unmodified bit stream, si, 140a. These gain parameters are already determined in the decoder 205a that produces si(n) 210a. Therefore, they are readily available to the scaling processor 310.

(iv) The adaptive codebook vector, v′(n), of the subframe excitation signal corresponding to the modified (scaled) bit stream, so, 140b is provided by the partial AMR decoder 340a.

(v) The scaled version of the adaptive codebook gain, ĝ′ₚ, after going through quantization/de-quantization processors 325, 330, is fed back to the JCS processor 320.

Note that the decoder 340a operating on the send-out modified bit stream, so, 140b need not be a full decoder. Since its output is the adaptive codebook vector, the LPC synthesis operation (Hₘ(z) in FIG. 5) need not be performed in this decoder 340a.

Let x(n) be the near-end signal before it is encoded and transmitted as the si bit stream 140a in FIG. 7A. Let gₚ be the adaptive codebook gain for a given subframe corresponding to x(n). According to the encoding, gₚ is computed as described by Adaptive Multi-Rate (AMR): Adaptive Multi-Rate (AMR) Speech Codec Transcoding Functions, 3^{rd} Generation Partnership Project Document number 3GPP TS 26.090, according to the following equation:

$${g}_{p} = \frac{{\sum }_{n = 0}^{N - 1} x ( n ) y ( n )}{{\sum }_{n = 0}^{N - 1} {y}^{2} ( n )} \qquad ( 5 )$$

where N is the number of samples in the subframe, and y(n) is the filtered adaptive codebook vector given by:
y(n)=v(n)*h(n) (6)

Here, v(n) is the adaptive codebook vector, and h(n) is the impulse response of the LPC synthesis filter.

If the near end speech input were scaled by G at any given subframe, then the adaptive codebook gain is determined according to

$${g}_{p}^{( s )} = \frac{G {\sum }_{n = 0}^{N - 1} x ( n ) y ( n )}{{\sum }_{n = 0}^{N - 1} {y}^{2} ( n )} = {Gg}_{p} \qquad ( 7 )$$

The resulting energy in the adaptive portion of the excitation signal is therefore given by

$${[ {g}_{p}^{( s )} ]}^{2} {\sum }_{n = 0}^{N - 1} {v}^{2} ( n ) = {G}^{2} {g}_{p}^{2} {\sum }_{n = 0}^{N - 1} {v}^{2} ( n ) \qquad ( 8 )$$

The criterion used in scaling the adaptive codebook gain, gₚ, is that the energy of the adaptive portion of the excitation is preserved. That is,

$${( {g}_{p}^{′} )}^{2} {\sum }_{n = 0}^{N - 1} {( {v}^{′} ( n ) )}^{2} = {G}^{2} {g}_{p}^{2} {\sum }_{n = 0}^{N - 1} {v}^{2} ( n ) \qquad ( 9 )$$

where v′(n) is the adaptive codebook vector of the (partial) decoder 340a operating on the scaled bit stream (i.e., the send-out bit stream, so), and g′ₚ is the scaled adaptive codebook gain that is quantized 325 and inserted 335 into the bit stream 140a to produce the send-out bit stream, so, 140b. Since the pitch lag is preserved and not modified as part of the scaling, v′(n) is based on the same pitch lag as v(n). However, since the scaled decoder has a scaled version of the excitation history, v′(n) is different from v(n).

The scaled adaptive codebook gain can be written as
g′ₚ=Kₚgₚ (10)

where Kₚ is the scaling factor for the adaptive codebook gain. According to Equation (9), Kₚ is given by:

$${K}_{p} = {G [ \frac{{\sum }_{n = 0}^{N - 1} {v}^{2} ( n )}{{\sum }_{n = 0}^{N - 1} {( {v}^{′} ( n ) )}^{2}} ]}^{1 / 2} \qquad ( 11 )$$

Turning now to the fixed codebook gain, the criterion used in scaling g_{c} is to preserve the speech signal energy. The total subframe excitation at the decoder that operates on the original bit stream, si, 140a is given by:
w(n)=gₚv(n)+g_{c}c(n) (12)

The energy of the resulting decoded speech signal in a given subframe is

$${E}_{x} = {\sum }_{n = 0}^{N - 1} {( w ( n ) * h ( n ) )}^{2} \qquad ( 13 )$$

where the initial conditions of the LPC filter, h(n), are preserved from the previous subframe synthesis. If the speech is scaled at any given subframe by G, then the speech energy becomes:

$${E}_{x}^{( s )} = {G}^{2} {\sum }_{n = 0}^{N - 1} {( w ( n ) * h ( n ) )}^{2} = {\sum }_{n = 0}^{N - 1} {( Gw ( n ) * h ( n ) )}^{2} \qquad ( 14 )$$

Therefore, scaling the speech is equivalent to scaling the total excitation by G. This is generally true if the initial conditions of h(n) are zero. However, an approximation is made that this relationship still holds even when the initial conditions are the true initial conditions of h(n). This approximation has an effect that the scaling of the decoded speech does not happen instantly. However, this scaling delay is relatively short for the acoustic echo suppression application.

Given equation (14) and the scaled adaptive gain of equation (10), the goal then becomes to determine the scaled fixed codebook gain, such that

$${E}_{x}^{( s )} = {G}^{2} {\sum }_{n = 0}^{N - 1} {w}^{2} ( n ) = {\sum }_{n = 0}^{N - 1} {( {w}^{′} ( n ) )}^{2} \qquad ( 15 )$$

where w′(n) is the total excitation corresponding to the scaled bit stream, so, 140b and is given by
w′(n)=g′ₚv′(n)+g′_{c}c(n) (16)

Note that the fixed codebook vector, c(n), is the same as the fixed codebook vector in equation (12) for w(n) since the scaling does not modify the fixed codebook vector. The goal then becomes:

$${G}^{2} {\sum }_{n = 0}^{N - 1} {w}^{2} ( n ) = {\sum }_{n = 0}^{N - 1} {( {g}_{p}^{′} {v}^{′} ( n ) + {g}_{c}^{′} c ( n ) )}^{2} \qquad ( 17 )$$

The adaptive codebook gain, g′ₚ, is determined by equations (10) and (11). However, to preserve the speech energy at the decoder, the quantized version of the gain, ĝ′ₚ, is used in Equation (17), resulting in

$${G}^{2} {\sum }_{n = 0}^{N - 1} {w}^{2} ( n ) = {\sum }_{n = 0}^{N - 1} {( {\hat{g}}_{p}^{′} {v}^{′} ( n ) + {g}_{c}^{′} c ( n ) )}^{2} \qquad ( 18 )$$

Equation (18) can be rewritten as a quadratic equation in g′_{c} as:

$$( {\sum }_{n = 0}^{N - 1} {c}^{2} ( n ) ) {( {g}_{c}^{′} )}^{2} + ( 2 {\sum }_{n = 0}^{N - 1} {\hat{g}}_{p}^{′} {v}^{′} ( n ) c ( n ) ) {g}_{c}^{′} + ( {\sum }_{n = 0}^{N - 1} {( {\hat{g}}_{p}^{′} {v}^{′} ( n ) )}^{2} - {G}^{2} {\sum }_{n = 0}^{N - 1} {w}^{2} ( n ) ) = 0 \qquad ( 19 )$$

Solving for the roots of the quadratic equation (19), the scaled fixed codebook gain, g′_{c}, is set to the positive real-valued root. In the event that both roots are real and positive, either root can be chosen. One strategy that may be used is to set g′_{c} to the root with the larger value. Another strategy is to set g′_{c} to the root that gives the closer value to Gg_{c}. The scale factor for the fixed codebook gain is then given by,

$${K}_{c} = \frac{{g}_{c}^{′}}{{g}_{c}} \qquad ( 20 )$$

where g′_{c} is a positive real-valued root of equation (19).

In some rare cases, no positive real-valued root exists for equation (19). The roots are either negative real-valued or complex, implying no valid answer exists for g′_{c}. This can be due to the effects of quantization. In these cases, a back-off scaling procedure may be performed, where K_{c} is set to zero, and the scaled adaptive codebook gain is determined by preserving the energy of the total excitation. That is,

$${K}_{p} = {G [ \frac{{\sum }_{n = 0}^{N - 1} {w}^{2} ( n )}{{\sum }_{n = 0}^{N - 1} {( {v}^{′} ( n ) )}^{2}} ]}^{1 / 2} \qquad ( 21 )$$

Experimental Results

To examine the performance of the JCS method, it may be compared it to the method where g_{c} is scaled by the desired scaling factor, G, similar to what is proposed in Beaugeant et al., supra. For reference, this method is referred to herein as the “Fixed Codebook Scaling” method.

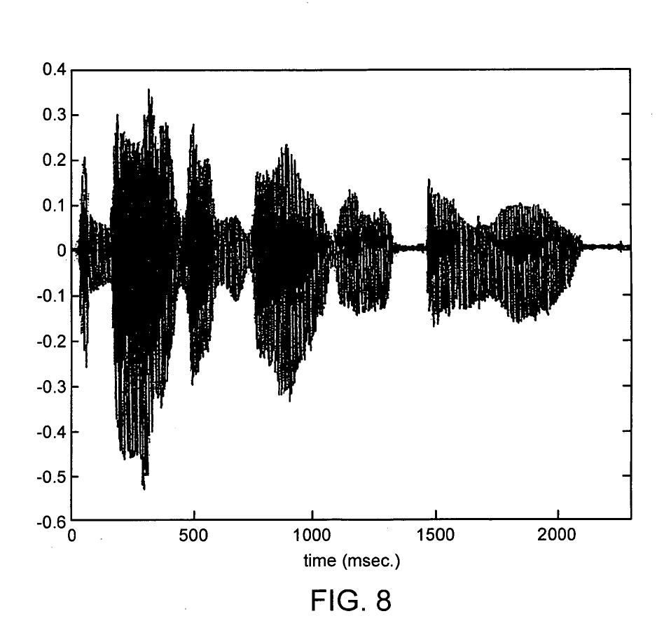

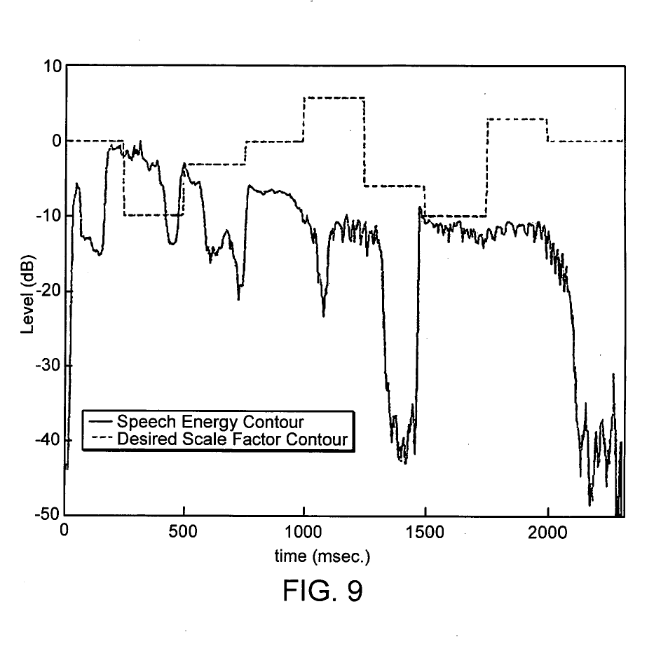

FIG. 8 shows a 12.2 kbps AMR decoded speech signal representing a sentence spoken by a female speaker. FIG. 9 shows the energy contour of this signal, where the energy is computed on 5 msec. segments. Superimposed on the energy contour in FIG. 9 is an example of a desired scale factor contour by which it is preferable to scale the signal in its coded domain, for reasons described above. This scale factor contour is manually constructed so as to have varying scaling conditions and scaling transitions.

The JCS method described above was applied to in this example. After performing the parameter scaling, the resulting bit stream was decoded into a linear domain signal. As the decoding operation was performed, the synthesized LPC excitation signal was also saved. The ratio of the energy of the LPC excitation signal corresponding to the scaled parameter bit stream to the energy of the LPC excitation corresponding to the original non-scaled parameter bit stream was then computed. Specifically, the following equation was computed

$${R}_{e} = \frac{{\sum }_{n = 0}^{N - 1} {( {w}^{′} ( n ) )}^{2}}{{\sum }_{n = 0}^{N - 1} {w}^{2} ( n )} \qquad ( 22 )$$

The excitation signal w′(n) in Equation (22) is the actual excitation signal seen at the decoder (i.e., after re-quantization of the scaled gain parameters). Ideally, Rₑ should track as much as possible the scale factor contour given in FIG. 9.

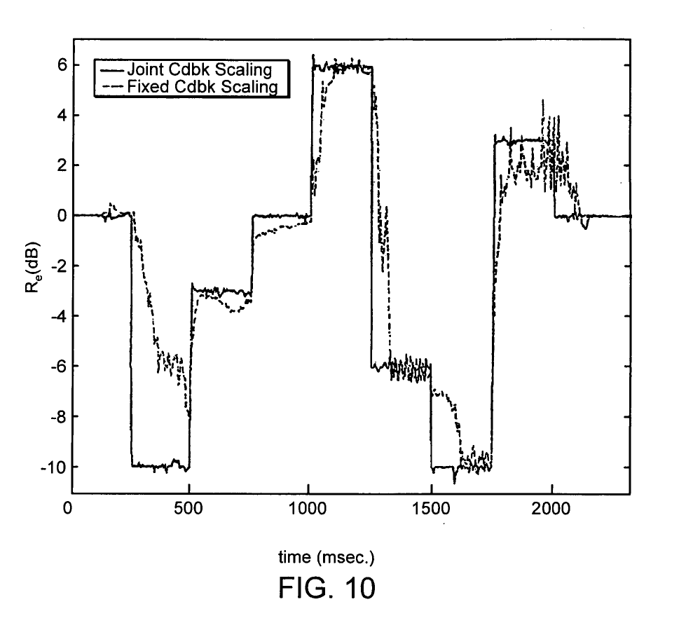

FIG. 10 shows a comparison of the ratio, Rₑ, between the JCS method and the Fixed Codebook Scaling method. It is clear from this figure, the JCS method tracks more closely the desired scaling factor contour. The ultimate goal, however, is to scale the resulting decoded speech signal.

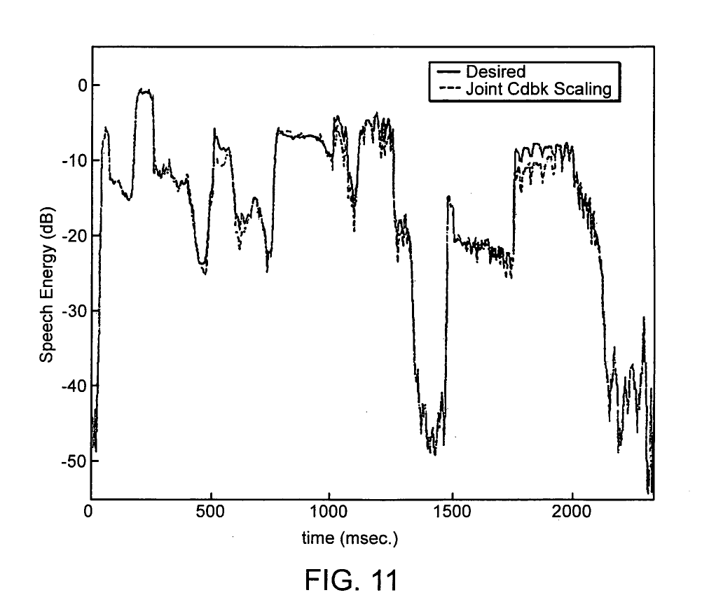

FIG. 11 shows the energy contour of the decoded speech signal using the JCS method superimposed on the desired energy contour of the decoded speech signal. This desired contour is obtained by multiplying (or adding in the log scale) the energy contour in FIG. 9 by the desired scaling factor that is superimposed on FIG. 9.

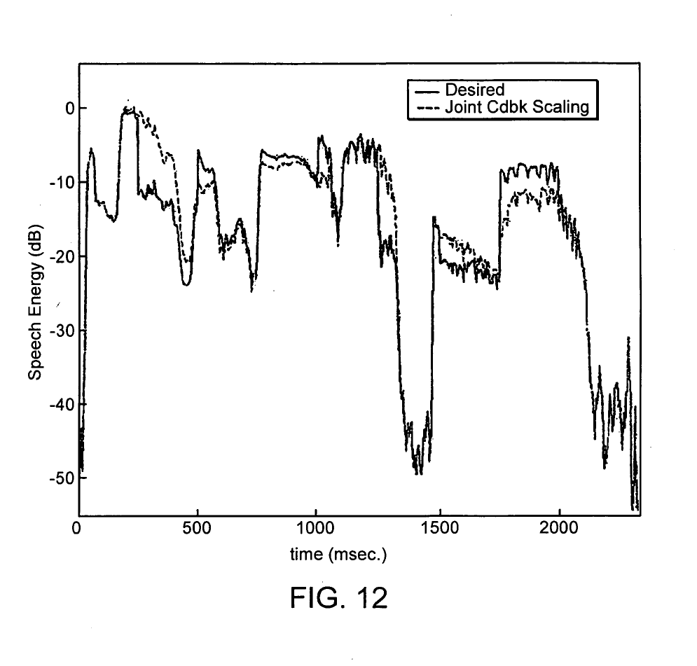

FIG. 12 is a similar plot for the Fixed Codebook Scaling. It can also be seen here that the JCS results in a better tracking of the desired speech energy contour.

CD-AES with Spectrally Matched Noise Injection (SMNI)

Typically in echo suppression, it is desirable to heavily suppress the signal when it is detected that there is only far end speech with no near end speech and that an echo is present in the send-in signal. This heavy suppression significantly reduces the echo, but it also introduces discontinuity in the signal, which can be discomforting or annoying to the far end listener. To remedy this, comfort noise is typically injected to replace the suppressed signal. The comfort noise level is computed based on the signal power of the background noise at the near end, which is determined during periods when neither the far end user nor the near end user is talking. Ideally, to make the signal even more natural sounding, the spectral characteristics of the comfort noise needs to match closely a background noise of the near end. When echo suppression is performed in the linear domain, Spectrally Matched Noise Injection (SMNI) is typically done by averaging a power spectrum during segments of no speech activity at both ends and then injecting this average power spectrum when the signal is to be suppressed. However, this procedure is not directly applicable to the coded domain. Here, a method and corresponding apparatus for SMNI is provided in the coded domain.

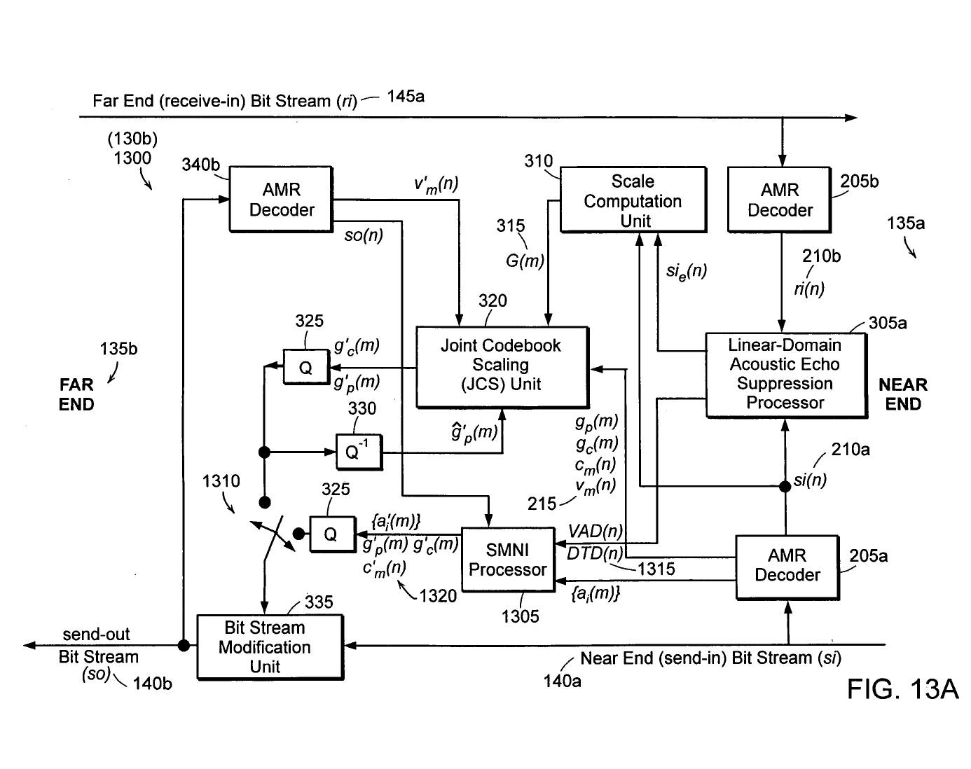

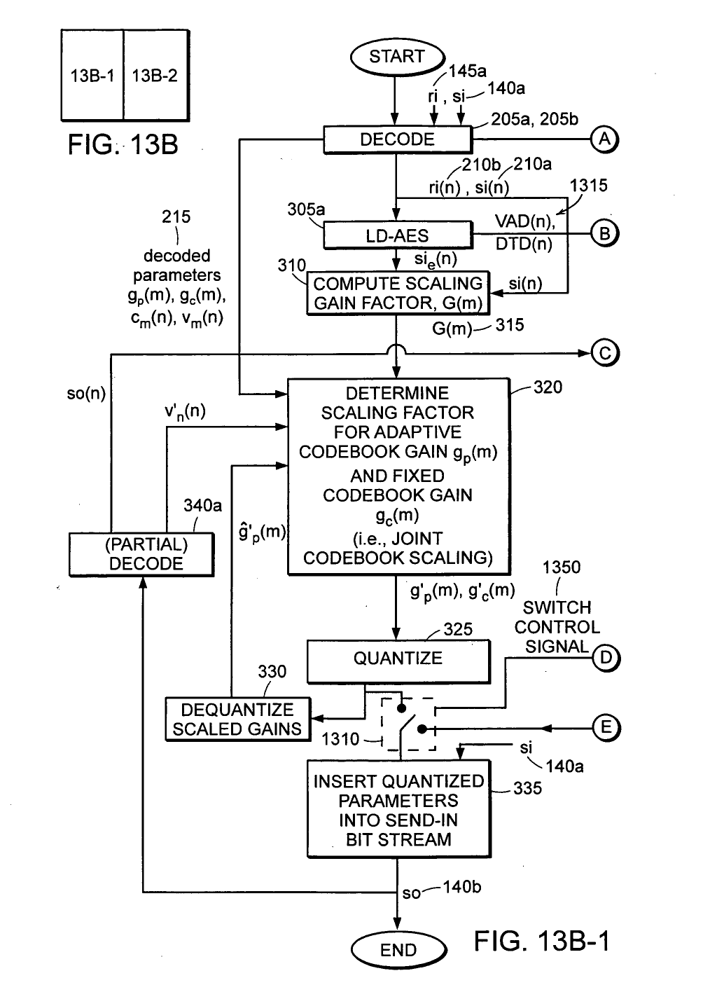

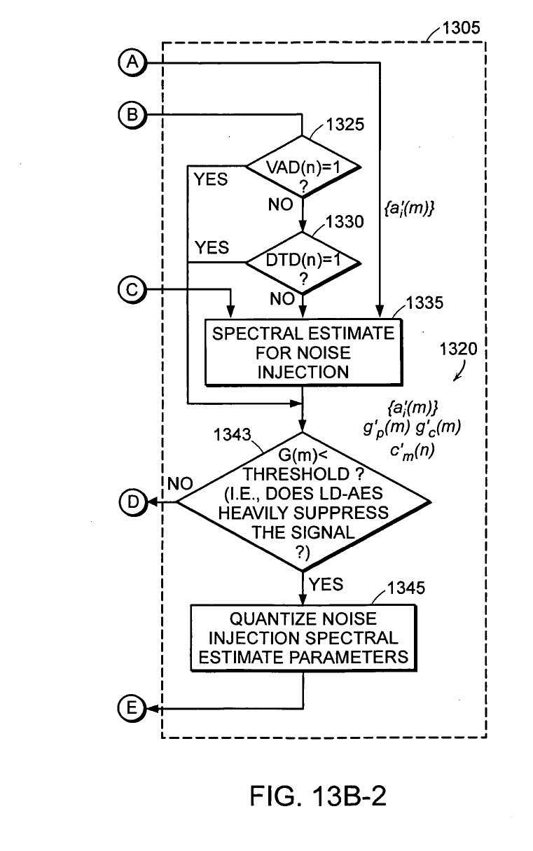

FIG. 13A is a block diagram of another exemplary embodiment of a CD-AES system 1300 that can be used to implement the CD-AES system 130b of FIGS. 4 and 7A. The Coded Domain Acoustic Echo Suppressor 1300 of FIG. 13A includes an SMNI processor 1305. The idea of the coded domain SMNI is to compute near end background noise spectral characteristics by averaging an amplitude spectrum represented by the LPC coefficients during periods when neither speaker (i.e., near-end and far-end) is speaking. Specifically, the CD-SMNI processor 1305 computes new {aᵢ(m)}, cₘ(n), g_{c}(m), and gₚ(m) parameters 1320 when the signal 140a is to be heavily suppressed.

The inputs to the CD-SNMI processor 1305 are as follows:

(i) the decoded LPC coefficients {aᵢ(m)};

(ii) the decoded fixed codebook vector cₘ(n);

(iii) The decoded send-out speech signal, so(n);

(iv) a Voice Activity Detector signal, VAD(n), which is typically determined as part of the Linear-Domain Echo Suppression. This signal indicates whether the near end is speaking or not; and

(v) a Double Talk Detector signal, DTD(n), which is typically determined as part of the Linear-Domain Echo Suppression 305a. This signal indicates whether both near-end and far-end speakers 105a, 105b are talking at the same time.

During frames when both VAD(n) and DTD(n) 1315 indicate no activity, implying no speech on either end of the call, the CD-SMNI processor 1305 computes a running average of the spectral characteristics of the signal 140a. The technique used to compute the spectral characteristics may be similar to the method used in a standard AMR codec to compute the background noise characteristics for use in its silence suppression feature. Basically, in the AMR codec, the LPC coefficients, in the form of line spectral frequencies, are averaged using a leaky integrator with a time constant of eight frames. The decoded speech energy is also averaged over the last eight frames. In the CD-SMNI processor 1305, a running average of the line spectral frequencies and the decoded speech energy is kept over the last eight frames of no speech activity on either end. When the CD-AES heavily suppresses the signal 140a (e.g., by more than 10 dB), the SMNI processor 1305 is activated to modify the send-in bit stream 140a and send, by way of a switch 1310 (which may be mechanical, electrical, or software), new coder parameters 1320 so that, when decoded at the far end, spectrally matched noise is injected. This noise injection is similar to the noise injection done during a silence insertion feature of the standard AMR decoder.

When noise is to be injected, the CD-SMNI processor 1305 determines new LPC coefficients, {a′ᵢ(m)}, based on the above mentioned averaging. Also, a new fixed codebook vector, c′ₘ(n), and a new fixed codebook gain, g′_{c}(m), are computed. The fixed codebook vector is determined using a random sequence, and the fixed codebook gain is determined based on the above mentioned decoded speech energy. The adaptive codebook gain, g′ₚ(m), is set to zero. These new parameters 1320 are quantized 325 and inserted 335 into the send-in bit stream 140a to produce the send-out bit stream 140b.

Note that, in contrast to FIG. 7A, the decoder 340b operating on the send-out bit stream, so, 140b in FIG. 13A is no longer a partial decoder since SMNI needs to have access to the decoded speech signal. However, since the decoded speech is used to compute its energy, the AMR decoder 340b can be partial in the sense that post-filtering need not be performed.

FIG. 13B is a flow diagram corresponding to the CD-AES system of FIG. 13A. In the flow diagram, example internal activities occurring in the SMNI processor 1305 are illustrated, which include a determination 1325 as to whether voice activity is detected and a determination 1330 whether double talk is present (i.e., whether both users 105a, 105b are speaking concurrently). If both determinations 1325, 1330 are false (i.e., there is silence on the line), then a spectral estimate for noise injection 1335 is updated. Thereafter, a determination 1340 as to whether the LD-AES heavily suppresses the signal is made. If it does, then the noise injection spectral estimate parameters are quantized 1345, and the switch 1310 is activated by a switch control signal 1350 to pass the quantized noise injection parameters. If the LD-AES does not heavily suppress the signal, then the switch 1310 allows the quantized, adaptive and fixed codebook gains that are determined by the JCS process to pass.

Coded Domain Noise Reduction (CD-NR)

A method and corresponding apparatus for performing noise reduction directly in the coded domain using an exemplary embodiment of the present invention is now described. As should become clear, no intermediate decoding/re-encoding is performed, thereby avoiding speech degradation due to tandem encodings and also avoiding significant additional delays.

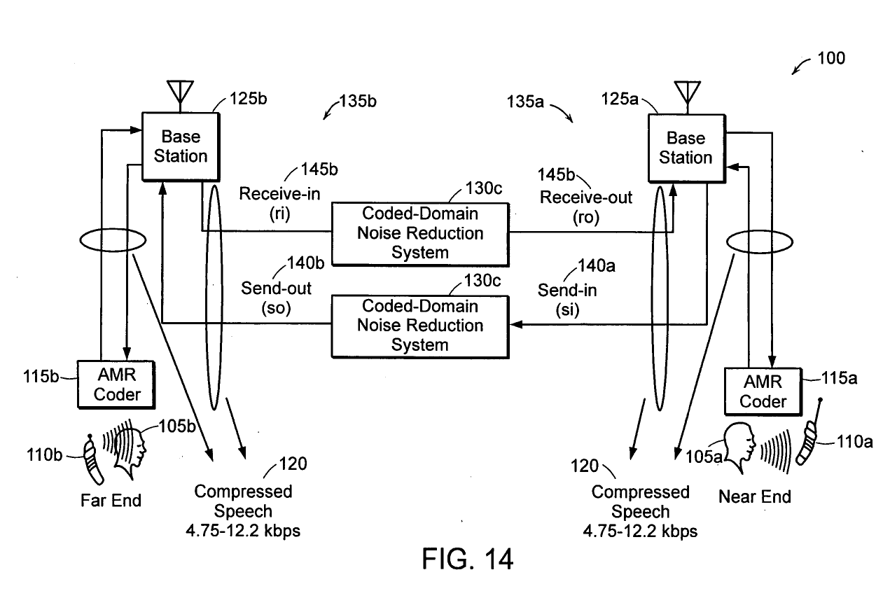

FIG. 14 is a block diagram of the network 100 employing a Coded Domain Noise Reduction (CD-NR) system 130c, where noise reduction is shown on both sides of the call. One side of the call is referred to herein as the near end 135a, and the other side of the call is referred to herein as the far end 135b. In this figure, the receive-in signal, ri, 145a, the send-in signal, si, 140a, and the send-out signal, so, 140b are bit streams representing compressed speech. Since the two noise reduction systems 130c are identical in operation, the description below focuses on the noise reduction system 130c that operates on the send-in signal, si, 140a.

The CD-NR system 130c presented herein is applicable to the family of speech coders based on Code Excited Linear Prediction (CELP). According to an exemplary embodiment of the present invention, the AMR set of coders is considered an example of CELP coders. However, the method for CD-NR presented herein is directly applicable to all coders based on CELP. Moreover, although the VQE processors described herein are presented in reference to CELP-based systems, the VQE processors are more generally applicable to any form of communications system or network that codes and decodes communications or data signals in which VQE processors or other processors can operate in the coded domain.

Three different methods of Coded Domain Noise Reduction are presented immediately below.

Method 1

A Coded Domain Noise Reduction method and corresponding apparatus is described herein whose performance approximates the performance of a Linear Domain-Noise Reduction technique. To accomplish this performance, after performing Linear-Domain Noise Reduction (LD-NR), the CD-NR system 130c extracts relevant information from the LD-NR processor. This information is then passed to a coded domain noise reduction processor.

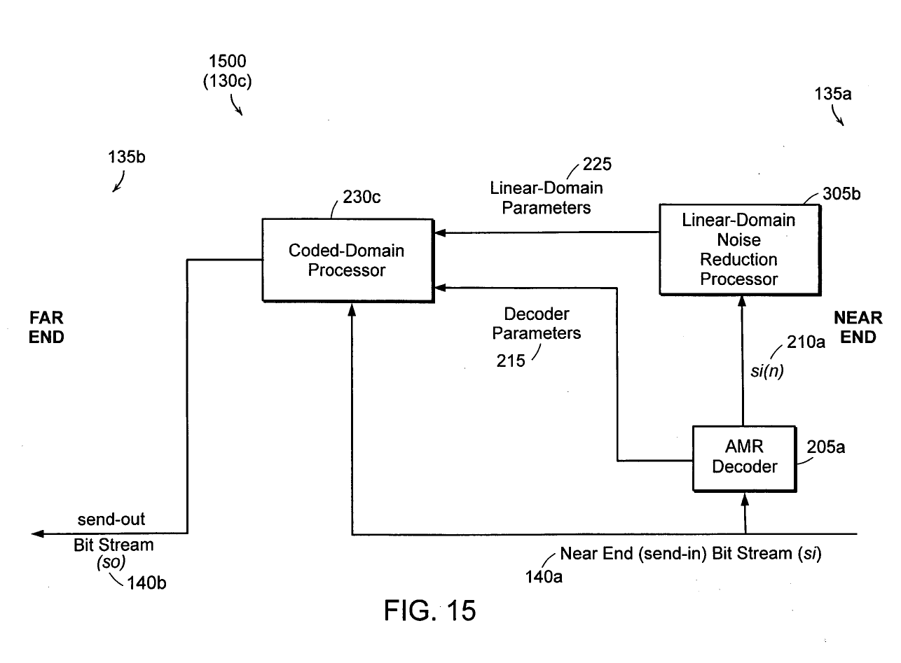

FIG. 15 is a high level block diagram of the approach taken. An exemplary CD-NR system 1500 may be used to implement the CD-NR system 130c introduced in FIG. 14. In FIG. 15, only the near-end side 135a of the call is shown, where noise reduction is performed on the send-in bit stream, si, 140a. The send-in bit stream 140a is decoded into the linear domain, si(n), 210a and then passed through a conventional LD-NR system 305b to reduce the noise in the si(n) signal 210a. Relevant information 215, 225 is extracted from both LD-NR and the AMR decoding processors 305b, 205a, and then passed to the coded domain processor 1500. The coded domain processor 1500 modifies the appropriate parameters in the si bit stream 140a to effectively reduce noise in the signal.

It should be understood that the AMR decoding 205a can be a partial decoding of the send-in signal 140a. For example, since LD-NR is typically concerned with noise estimation and reduction, the post-filter present in the AMR decoder 205a need not be implemented. It should further be understood that, although the si signal 140a is decoded 205a into the linear domain, no intermediate decoding/re-encoding, which can degrade the speech quality, is being introduced. Rather, the decoded signal 210a is used to extract relevant information 225 that aids the coded domain processor 1500 and is not re-encoded after the LD-NR processor 305b is performed.

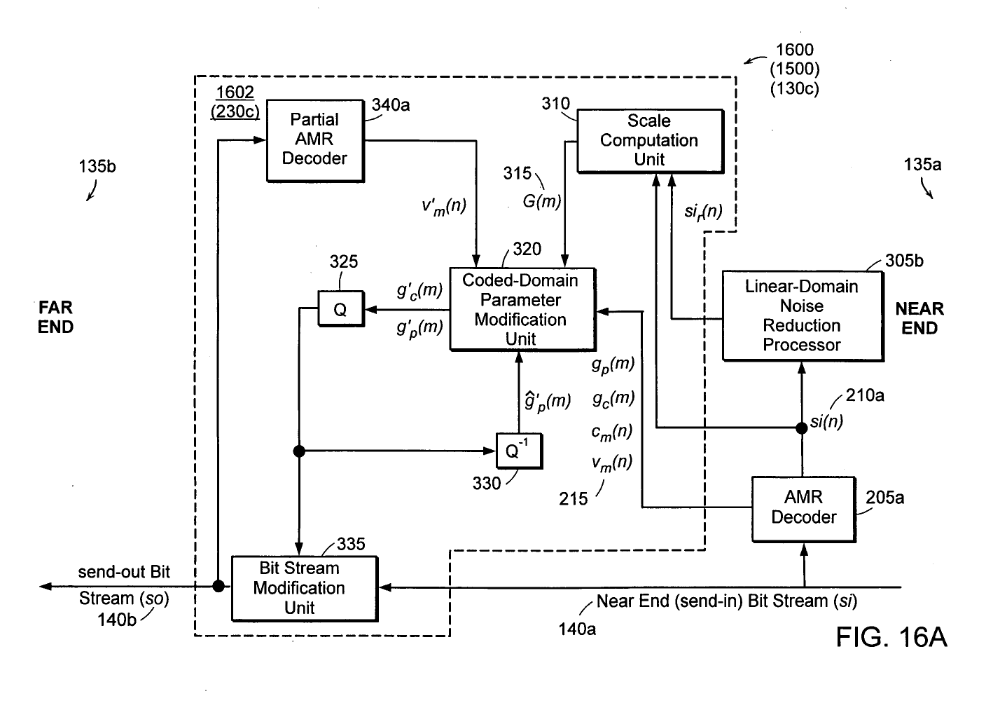

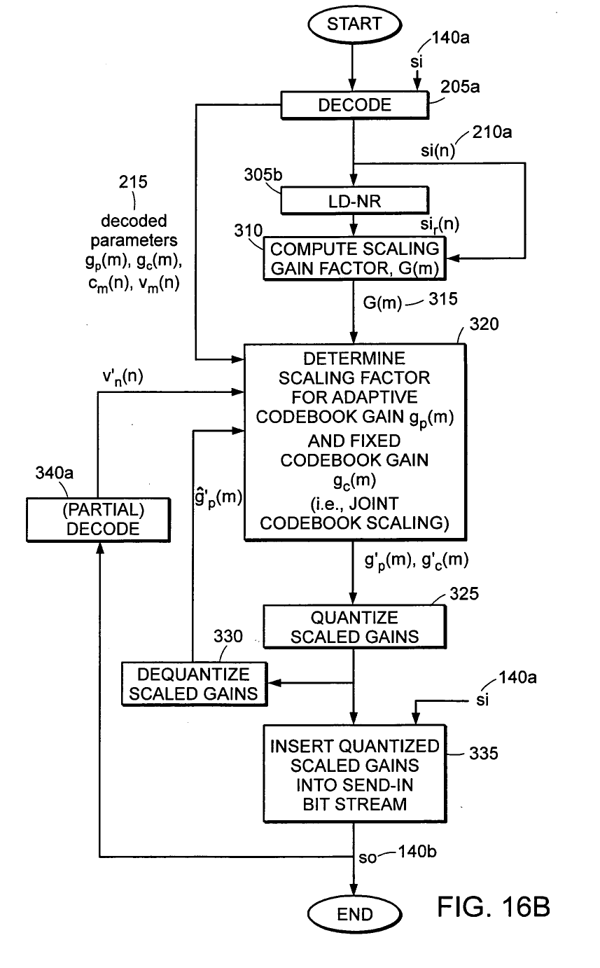

FIG. 16A shows a detailed block diagram of another exemplary embodiment of a CD-NR system 1600 used to implement the CD-NR systems 130c and 1500. Typically, the LD-NR system 305b decomposes the signal into its frequency-domain components using a Fast Fourier Transform (FFT). In most implementations, the frequency components range between 32 and 256. Noise is estimated in each frequency component during periods of no speech activity. This noise estimate in a given frequency component is used to reduce the noise in the corresponding frequency component of the noisy signal. After all the frequency components have been noise reduced, the signal is converted back to the time-domain via an inverse FFT.

An important observation about the Linear Domain Noise Reduction is that if a comparison of the energy of the original signal si(n) 210a to the energy of the noise reduced signal siᵣ(n) is made, one finds that different speech segments are scaled differently. For example, segments with high Signal-to-Noise Ratio (SNR) are scaled less than segments with low SNR. The reason for that lies in the fact that noise reduction is being done in the frequency domain. It should be understood that the effect of LD-NR in the frequency domain is more complex than just segment-specific time-domain scaling. But, one of the most audible effects is the fact that the energy of different speech segments are scaled according to their SNR. This gives motivation to the CD-NR using an exemplary embodiment of the present invention, which transforms the problem of Noise Reduction in the coded domain to one of adaptively scaling the signal.

The scaling factor 315 for a given frame is the ratio between the energy of the noise reduced signal, siᵣ(n), and the original signal, si(n) 210a. The “Coded Domain Parameter Modification” unit 320 in FIG. 16A is the Joint Codebook Scaling (JCS) method described above. In JCS, both the CELP adaptive codebook gain, gₚ(m), and the fixed codebook gain, g′_{c}(m), are scaled. They are then quantized 325 and inserted 335 in the send-out bit stream, so, 140b replacing the original gain parameters present in the si bit stream 140a. These scaled gain parameters, when used along with the other decoder parameters 215 in the AMR decoding processor 205a, produce a signal that is an adaptively scaled version of the original noisy signal, si(n), 210a, which produces a reduced noise signal approximating the reduced noise, linear domain signal, siᵣ(n), which may be referred to as a target signal.

Below is a summary of the operations in the proposed CD-NR system 1600 shown in FIG. 16A and presented in the form of a flow diagram in FIG. 16B:

(i) The bit stream si 140a is decoded into a linear domain signal, si(n) 210a.

(ii) A Linear-Domain Noise Reduction system 305b that operates on si(n) 210a is performed. The LD-NR output is the signal siᵣ(n), which represents the send-in signal, si(n), 210a after noise is reduced and may be referred to as the target signal.

(iii) A scale computation 310 that determines the scaling factor 315 between si(n) 210a and siᵣ(n) is performed. A single scaling factor, G(m), 315 is computed for every frame (or subframe) by buffering a frame worth of samples of si(n) 210a and siᵣ(n) and determining the ratio between them. Here, the index, m, is the frame number index. One possible method for computing G(m) 315 is a simple power ratio between the two signals in a given frame. Other methods include computing a ratio of the absolute value of every sample of the two signals in a frame, and then taking a median or average of the sample ratio for the frame, and assigning the result to G(m) 315. The scale factor 315 can be viewed as the factor by which a given frame of si(n) 210a has to be scaled to reduce the noise in the signal. The frame duration of the scale computation is equal to the subframe duration of the CELP coder. For example, in the AMR 12.2 kbps coder 205a, the subframe duration is 5 msec. The scale computation frame duration is therefore set to 5 msec.

(iv) The scaling factor, G(m), 315 is used to determine a scaling factor for both the adaptive codebook gain and the fixed codebook gain parameters of the coder. The Coded-Domain Parameter Modification unit 320 employs the Joint Codebook Scaling method to scale gₚ(m) and g_{c}(m).

(v) The scaled gains are quantized 325 and inserted 335 into the send-out bit stream, so, 140b by substituting the original quantized gains in the si bit stream 140a.

Method 2

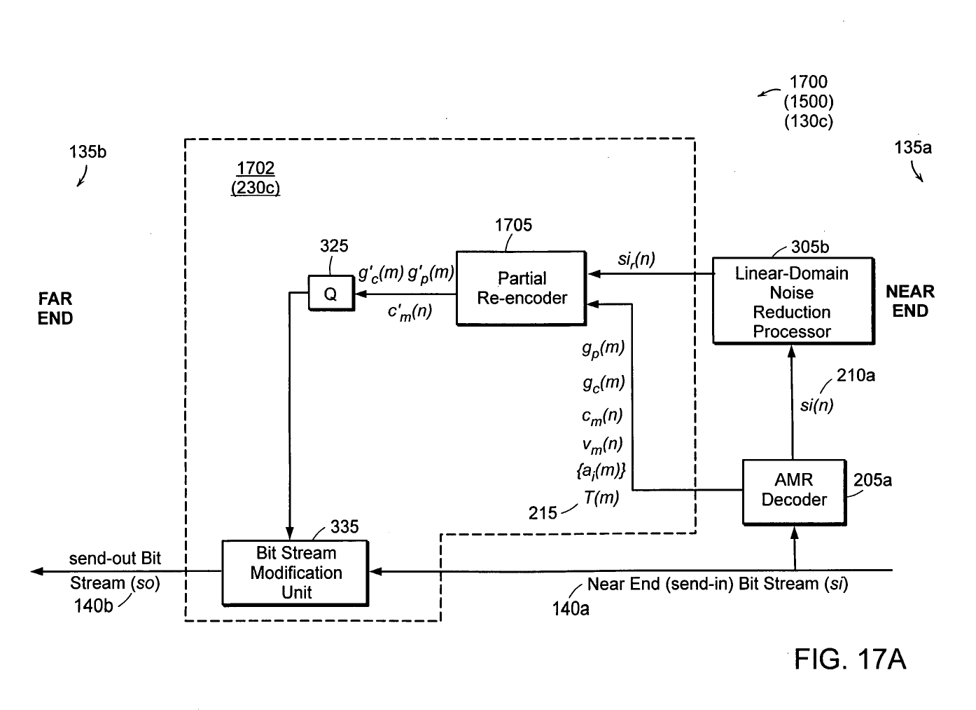

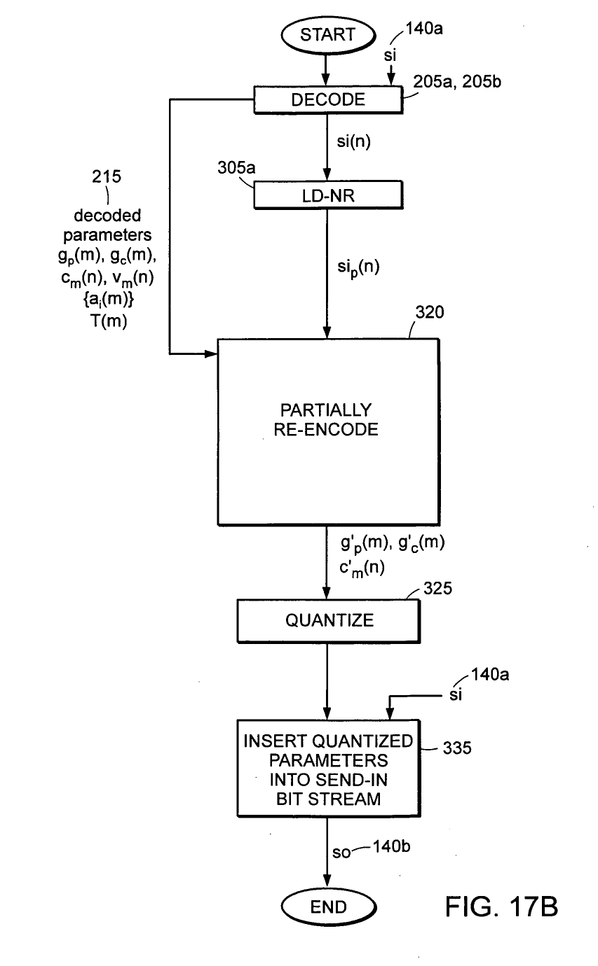

FIG. 17A is a block diagram illustrating another exemplary embodiment of a CD-NR system 1700 used to implement the CD-NR systems 130c, 1500. In this embodiment, the linear domain noise-reduced signal, siᵣ(n), is re-encoded by a partial re-encoder 1705. However, the re-encoding is not a full re-encoding. Rather, it is partial in the sense that some of encoded parameters in the send-in signal bit stream, si, 140a are kept, while others are re-estimated and re-quantized. In one example implementation, the LPC parameters, {a′(m)}, and the pitch lag value, T(m), are kept the same as what is contained in the si bit stream 140a. The adaptive codebook gain, gₚ(m), the fixed codebook vector, cₘ(n), and the fixed codebook gain, g_{c}(m), are re-estimated, re-quantized, and then inserted into the send-out bit stream, so, 140b. Re-estimating these parameters is the same process used in the regular AMR encoder. The difference is that, in the re-encoding processor 1705, the LPC parameters, {a′(m)}, and the pitch lag value, T(m), are not re-estimated but assigned the specific values corresponding to the si bit stream 140a. As such, this re-encoding 1705 is a partial re-encoding.

FIG. 17B is a flow diagram of a method corresponding to the embodiment of the CD-NR system 1700 of FIG. 7A.

Method 3

Comparing Method 1 to Method 2 for CD-NR, it is noted that one of the major differences between them is that the fixed codebook vector, c_{m,}(n), is re-estimated in Method 2. This re-estimation is performed using a similar procedure to how cₘ(n) is estimated in the standard AMR encoder. It is well known, however, that the computational requirements needed for re-estimating cₘ(n) is rather large. It is also useful to note that at relatively medium to high Signal-to-Noise Ratio (SNR), the performance of Method 1 matches very closely the performance of the Linear Domain Noise Reduction system. At relatively low SNR, there is more audible noise in the speech segments of Method 1 compared to the LD-NR system 305b. Method 2 can reduce this noise in the low SNR cases. One way to incorporate the advantages of Method 2, without the full computational requirements needed for Method 2, is to combine Method 1 and 2 in the following way. A byproduct of most Linear-Domain Noise Reduction is an on-going estimate of the Signal-to-Noise Ratio of the original noisy signal. This SNR estimate can be generated for every subframe. If it is detected that the SNR is medium to large, follow the procedure outlined in Method 1. If it is detected that the SNR is relatively low, follow the procedure outlined in Method 2.

Coded Domain Adaptive Level Control (CD-ALC)

A method and corresponding apparatus for performing adaptive level control directly in the coded domain using an exemplary embodiment of the present invention is now presented. As should become clear, no intermediate decoding/re-encoding is performed, thus avoiding speech degradation due to tandem encodings and also avoiding significant additional delays.

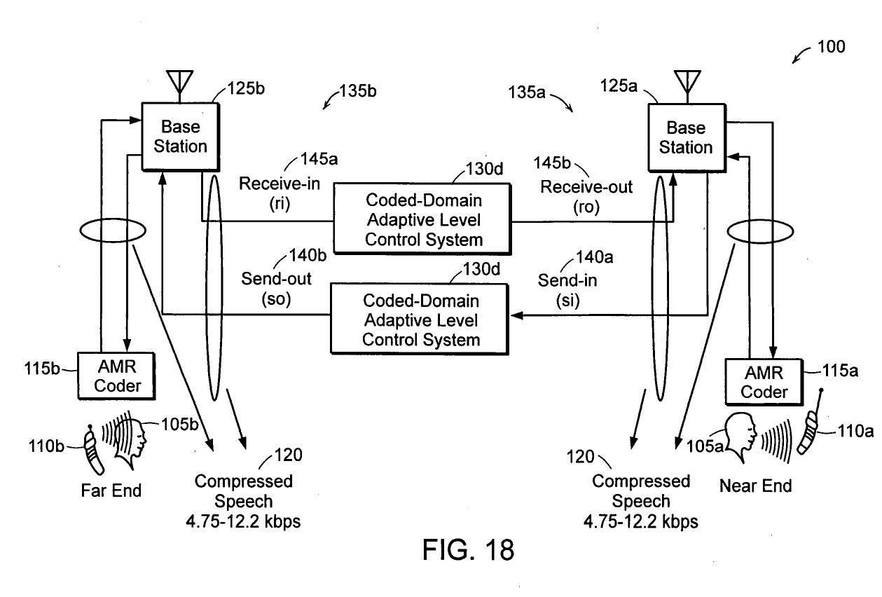

FIG. 18 is a block diagram of the network 100 employing a Coded Domain Adaptive Level Control (CD-ALC) system 130d using an exemplary embodiment of the present invention, where the adaptive level control is shown on both sides of the call. One side of the call is referred to herein at the near end 135a and the other side is referred to herein as the far end 135b. In this figure, the receive-in signal, ri, 145a, the send-in signal, si, 140a, and the send-out signal, so, 140b are bit streams representing compressed speech. Since the two adaptive level control systems 130d are identical in operation, the description below focuses on the CD-ALC system 130d that operates on the send-in signal, si, 140a.

The CD-ALC method and corresponding apparatus presented herein is applicable to the family of speech coders based on Code Excited Linear Prediction (CELP). According to an exemplary embodiment of the present invention, the AMR set of coders is considered as an example of CELP coders. However, the method and corresponding apparatus for CD-ALC presented herein is directly applicable to all coders based on CELP.

A Coded Domain Adaptive Level Control method and corresponding apparatus are described herein whose performance matches the performance of a corresponding Linear-Domain Adaptive Level Control technique. To accomplish this matching performance, after performing Linear-Domain Adaptive Level Control (LD-ALC), the CD-ALC system 130d extracts relevant information from the LD-ALC processor 305c. This information is then passed to the Coded Domain Adaptive Level Control system 130d.

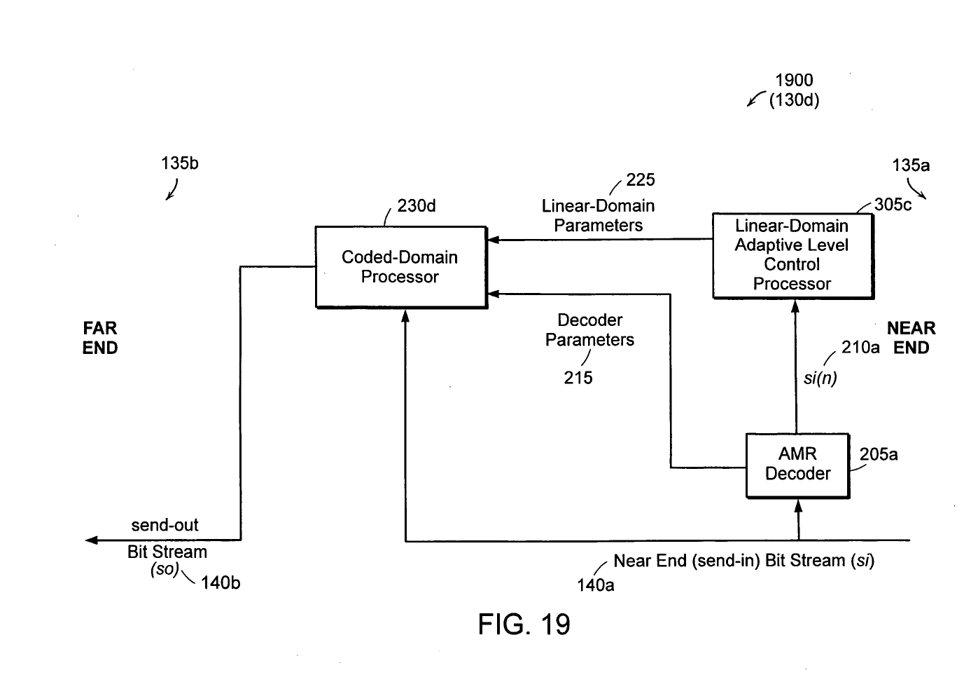

FIG. 19 shows a high level block diagram of an exemplary embodiment of a CD-ALC system 1900 that can be used to implement the CD-ALC system of FIG. 18. In FIG. 19, only the near-end side 135a of the call is shown, where Adaptive Level Control is performed on the send-in bit stream, si, 140a. The send-in bit stream 140a is decoded into the linear domain, si(n), 210a and then passed through a conventional LD-ALC system 305c to adjust the level of the si(n) signal 210a. Relevant information 225, 215 is extracted from both LD-ALC and the AMR decoding processors 305c, 205a, and then passed to the coded domain processor 230d. The coded domain processor 230d modifies the appropriate parameters in the si bit stream 140a to effectively reduce noise in the signal.

It should be understood that the AMR decoding 205a can be a partial decoding of the send-in bit stream signal 140a. For example, since LD-ALC processor 305c is typically concerned with determining signal levels, the post-filter present in the AMR decoder 205a need not be implemented. It should further be understood that, although the si signal 140a is decoded into the linear domain, no intermediate decoding/re-encoding, which can degrade the speech quality, is being introduced. Rather, the decoded signal 210a is used to extract relevant information 215, 225 that aids the coded domain processor 230d and is not re-encoded after the LD-ALC processor 1900.

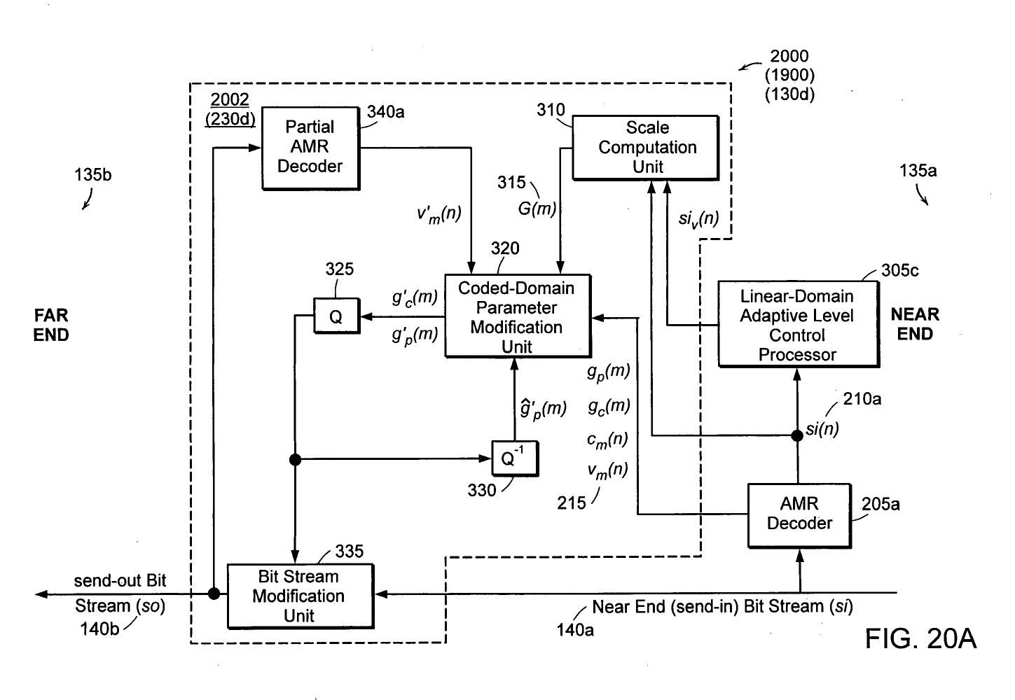

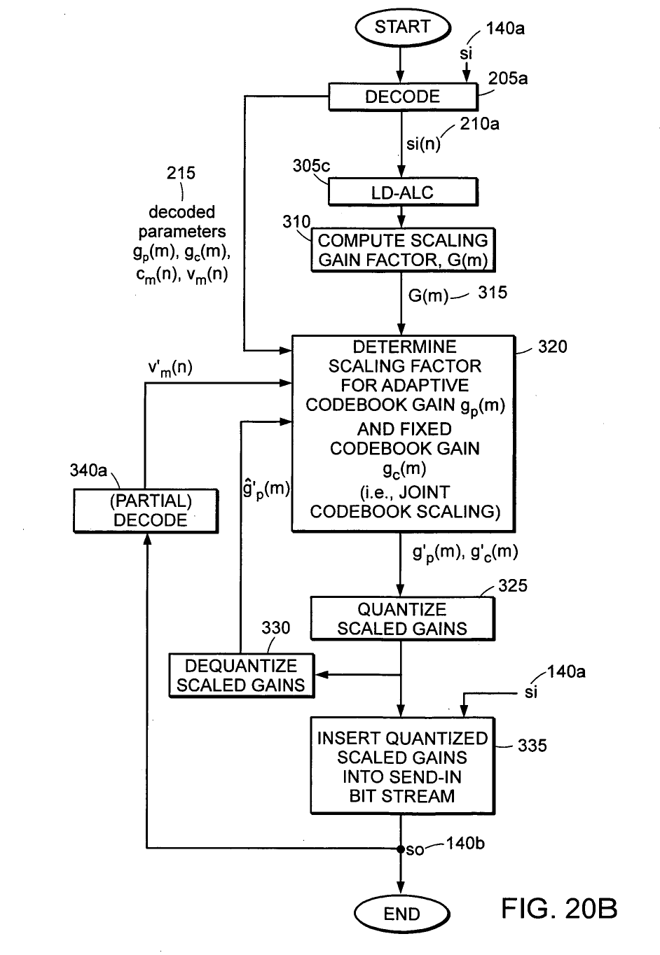

FIG. 20A is a detailed block diagram of an exemplary embodiment of a CD-ALC system 2000 that can be used to implement the CD-ALC systems 130d, 1900. The CD-ALC system 2000 also includes an embodiment of a coded domain processor 2002 introduced as the coded domain processor 230d in FIGS. 2 and 19. Typically, the LD-ALC system 305c determines an adaptive scaling factor 315 for the signal on a frame by frame basis, so the problem of Adaptive Level Control in the coded domain is transformed to one of adaptively scaling the signal 140a. The scaling factor 315 for a given frame is determined by the LD-ALC processor 305c. The “Coded Domain Parameter Modification” unit 320 in FIG. 20A may be the Joint Codebook Scaling (JCS) method described above. In JCS, both the CELP adaptive codebook gain and the fixed codebook gain are scaled. They are then quantized 325 and inserted 335 in the send-out bit stream, so, 140b, replacing the original gain parameters present in the si bit stream 140a. These scaled gain parameters, when used along with the other decoder parameters 215 in the AMR decoding processor 205a, produce a signal that is an adaptively scaled version of the original signal, si(n), 210a.

The operations in the CD-ALC system 2000 shown in FIG. 20A are summarized immediately below and presented in flow diagram form in FIG. 20B:

(i) The bit stream si is decoded into the linear signal, si(n).

(ii) A Linear-Domain Adaptive Level Control system 305c that operates on si(n) is performed. The LD-ALC output is the signal siᵥ(n) which represents the send-in signal, si(n), 210a after adaptive level control and may be referred to as the target signal.

(iii) A scale computation 310 that determines the scaling factor 315 between si(n) 210a and siᵥ(n) is performed. A single scaling factor, G(m), 315 is computed for every frame (or subframe) by buffering a frame worth of samples of si(n) 210a and siᵥ(n) and determining the ratio between them. Here, the index, m, is the frame number index. One possible method for computing G(m) 315 is a simple power ratio between the two signals in a given frame. Other methods include computing a ratio of the absolute value of every sample of the two signals in a frame, and then taking a median or average of the sample ratio for the frame, and assigning the result to G(m) 315. The scale factor 315 can be viewed as the factor by which a given frame of si(n) 210a has to be scaled to reduce the noise in the signal. The frame duration of the scale computation is equal to the subframe duration of the CELP coder. For example, in the AMR 12.2 kbps coder 205a, the subframe duration is 5 msec. The scale computation frame duration is therefore set to 5 msec.

(iv) The scaling factor, G(m), 315 is used to determine a scaling factor for both the adaptive codebook gain and the fixed codebook gain parameters of the coder. The Coded-Domain Parameter Modification unit 320 employs the Joint Codebook Scaling method to scale gₚ(m) and g_{c}(m).

(v) The scaled gains are quantized and inserted into the send-out bit stream, so, 140b by substituting the original quantized gains in the si bit stream 140a.

Coded Domain Adaptive Gain Control (CD-AGC)

A method and corresponding apparatus for performing adaptive gain control directly in the coded domain using an exemplary embodiment of the present invention is now presented. As should become clear, no intermediate decoding/re-encoding is performed, thus avoiding speech degradation due to tandem encodings and also avoiding significant additional delays.

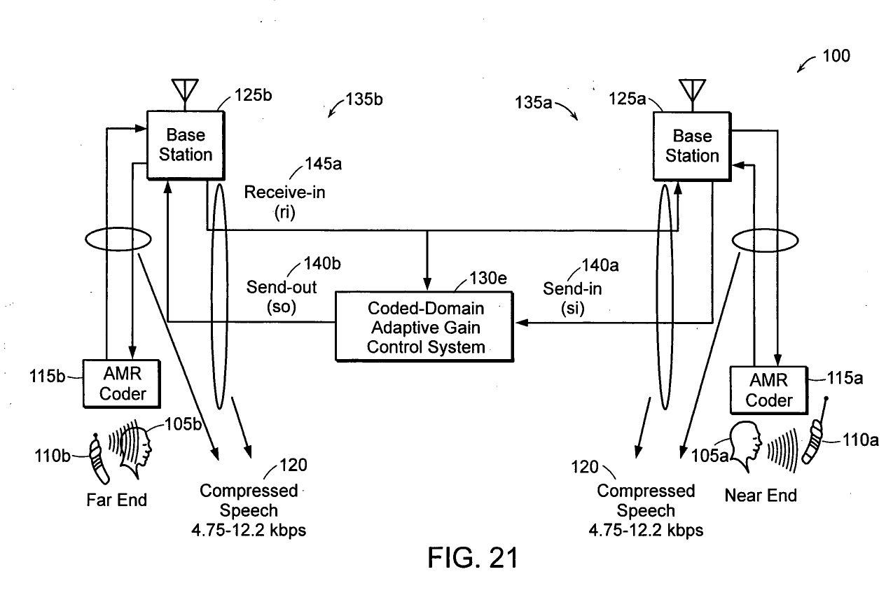

FIG. 21 is a block diagram of the network 100 employing a Coded Domain Adaptive Gain Control (CD-AGC) system 130e, where the adaptive gain control is shown in one direction. One call side is referred to herein as the near end 135a, and the other call side is referred to herein as the far end 135b. In this figure, the receive-in signal, ri, 145a, the send-in signal, si, 140a, and the send out signal, so, 140b are bit streams representing compressed speech. Since the adaptive gain control systems 130e for both directions are identical in operation, focus herein is on the system 130e that operates on the send-in signal, si, 140a.

The CD-AGC method and corresponding apparatus presented herein is applicable to the family of speech coders based on Code Excited Linear Prediction (CELP). According to an exemplary embodiment of the present invention, the AMR set of coders is considered as an example of CELP coders. However, the method and corresponding apparatus for CD-AGC presented herein is directly applicable to all coders based on CELP.

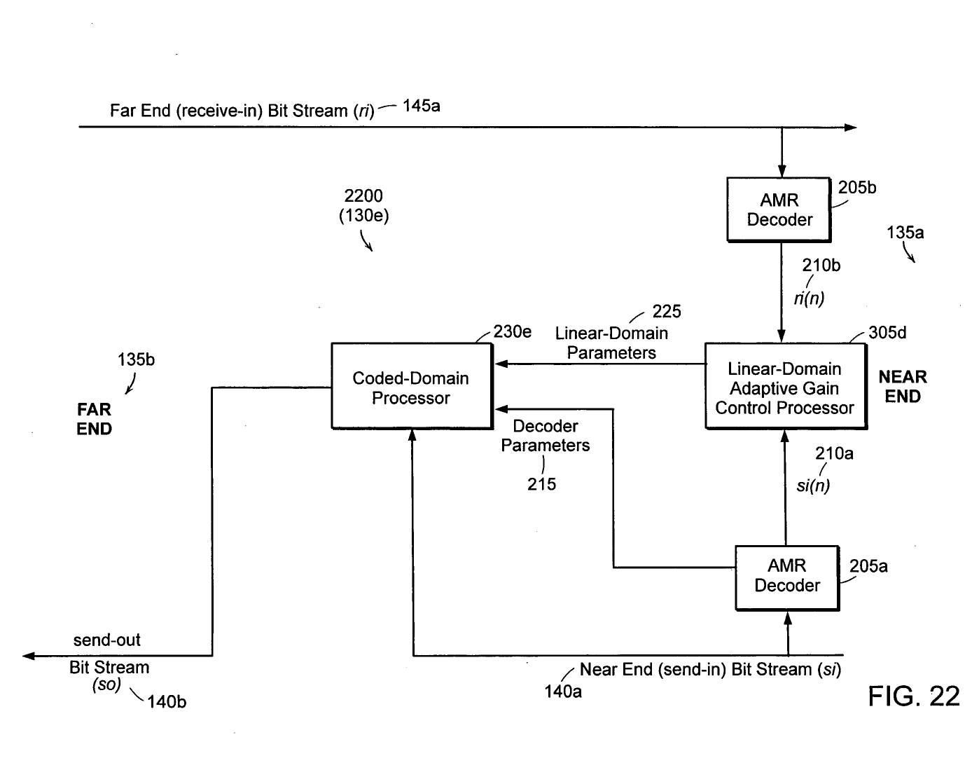

FIG. 22 is a high level block diagram of an exemplary embodiment of an LD-AGC system 2200 used to implement the LD-AGC system 130e introduced in FIG. 21. Referring to FIG. 22, the basic approach of the method and corresponding apparatus for Coded Domain Adaptive Gain Control according to the principles of the present invention makes use of advances that have been made in the Linear-Domain Adaptive Gain Control Field. A Coded Domain Adaptive Gain Control method and corresponding apparatus are described herein whose performance matches the performance of a corresponding Linear-Domain Adaptive Gain Control (LD-AGC) technique. To accomplish this matching performance, the LD-AGC is used to calculate the desired gain for adaptive gain control. This information is then passed to the Coded Domain Adaptive Gain Control.

Specifically, FIG. 22 is a high level block diagram of the approach taken. In this figure, Adaptive Gain Control is performed on the send-in bit stream, si. The send-in and receive-in bit streams 140a, 145a are decoded 205a, 205b into the linear domain, si(n) 210a and ri(n) 210b, and then passed through a conventional LD-AGC system 305d to adjust the level of the si(n) signal 210a. Relevant information 225, 215 is extracted from both LD-AGC and the AMR decoding processors 305d, 205a, and then passed to the coded domain processor 230e. The coded domain processor 230e modifies the appropriate parameters in the si bit stream 140a to effectively adjust its level.

It should be understood that the AMR decoding 205a, 205b can be a partial decoding of the two signals 140a, 145a. For example, since LD-AGC is typically concerned with determining signal levels, the post-filter (Hₘ(z), FIG. 5) present in the AMR decoder 205a, 205b need not be implemented. It should further be understood that, although the si signal 140a is decoded into the linear domain, no intermediate decoding/re-encoding that can degrade the speech quality is being introduced. Rather, the decoded signal 210a is used to extract relevant information that aids the coded domain processor 230e and is not re-encoded after the LD-AGC processor 305d.

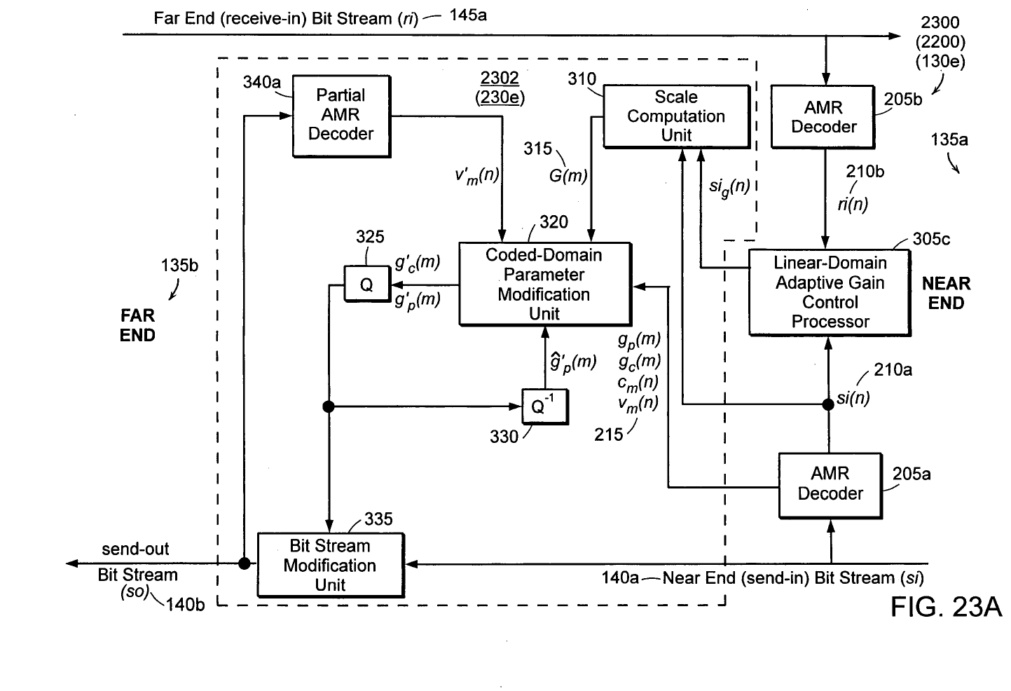

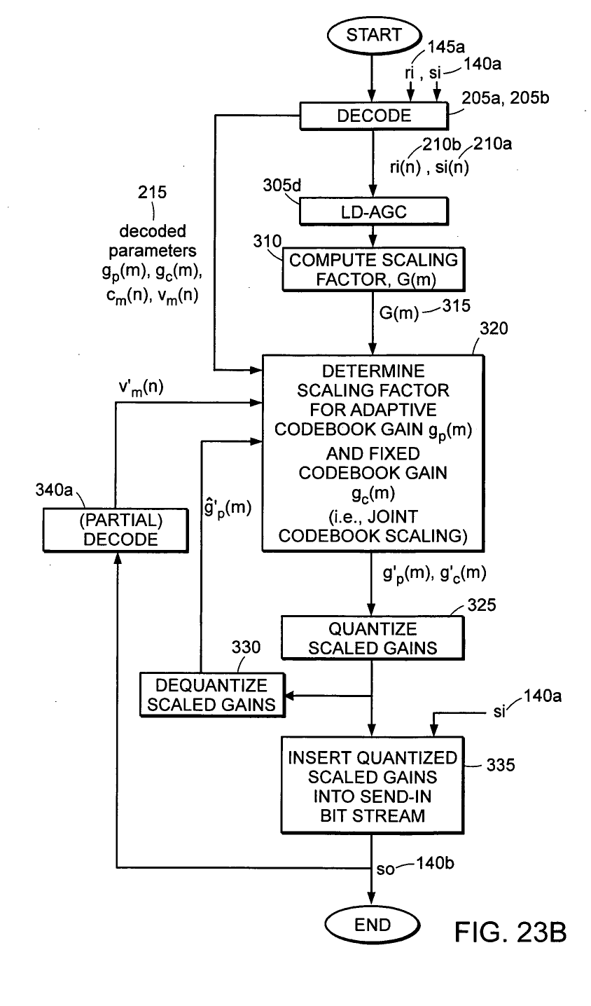

FIG. 23A is a detailed block diagram of an exemplary embodiment of a CD-AGC system 2300 used to implement the CD-AGC systems 130e and 2200. Typically, the LD-AGC system 2200 determines an adaptive scaling factor 315 for the signal on a frame by frame basis. Therefore, the problem of Adaptive Gain Control in the coded domain can be considered one of adaptively scaling the signal. The scaling factor 315 for a given frame is determined by the LD-AGC processor 305d. The CD-AGC system 2300 includes an exemplary embodiment of a coded domain processor 2302 used to implement the coded domain processor 230e of FIG. 22. A “Coded Domain Parameter Modification” unit 320 in FIG. 23A may employ the Joint Codebook Scaling (JCS) method described above. In JCS, both the CELP adaptive codebook gain, gₚ(m), and the fixed codebook gain, g_{c}(m), are scaled. They are then quantized 325 and inserted 335 in the send-out bit stream, so, 140b replacing the original gain parameters present in the si bit stream 140a. These scaled gain parameters, when used along with the other decoder parameters 215 in the AMR decoding processor 205a, produce a signal that is an adaptively scaled version of the original signal, si(n), 210a.

The operations in the CD-AGC system 2300 shown in FIG. 23A and presented in flow diagram form in FIG. 23B are summarized immediately below:

(i) The receive input signal bit stream ri 145a is decoded into the linear domain signal, ri(n), 210b.

(ii) The send-in bit stream si 140a is decoded into the linear domain signal, si(n), 210a.

(iii) A Linear-Domain Adaptive Gain Control system 305d that operates on ri(n) 210b and si(n) 210a is performed. The LD-AGC output is the signal, si_{g}(n) which represents the send-in signal, si(n), 210a after adaptive gain control and may be referred to as the target signal.

(iv) A scale computation 310 that determines the scaling factor 315 between si(n) 210a and si_{g}(n) is performed. A single scaling factor, G(m), 315 is computed for every frame (or subframe) by buffering a frame worth of samples of si(n) 210a and siᵥ(n) and determining the ratio between them. Here, the index, m, is the frame number index. One possible method for computing G(m) 315 is a simple power ratio between the two signals in a given frame. Other methods include computing a ratio of the absolute value of every sample of the two signals in a frame, and then taking a median or average of the sample ratio for the frame, and assigning the result to G(m) 315. The scale factor 315 can be viewed as the factor by which a given frame of si(n) 210a has to be scaled to reduce the noise in the signal. The frame duration of the scale computation is equal to the subframe duration of the CELP coder. For example, in the AMR 12.2 kbps coder 205a, the subframe duration is 5 msec. The scale computation frame duration is therefore set to 5 msec.

(v) The scaling factor, G(m), 315 is used to determine a scaling factor for both the adaptive codebook gain and the fixed codebook gain parameters of the coder. The Coded-Domain Parameter Modification unit 320 employs the Joint Codebook Scaling method to scale gₚ(m) and g_{c}(m)

(vi) The scaled gains are quantized 325 and inserted 335 into the send-out bit stream, so, 140b by substituting the original quantized gains in the si bit stream 140a.

CD-VQE Distributed About a Network

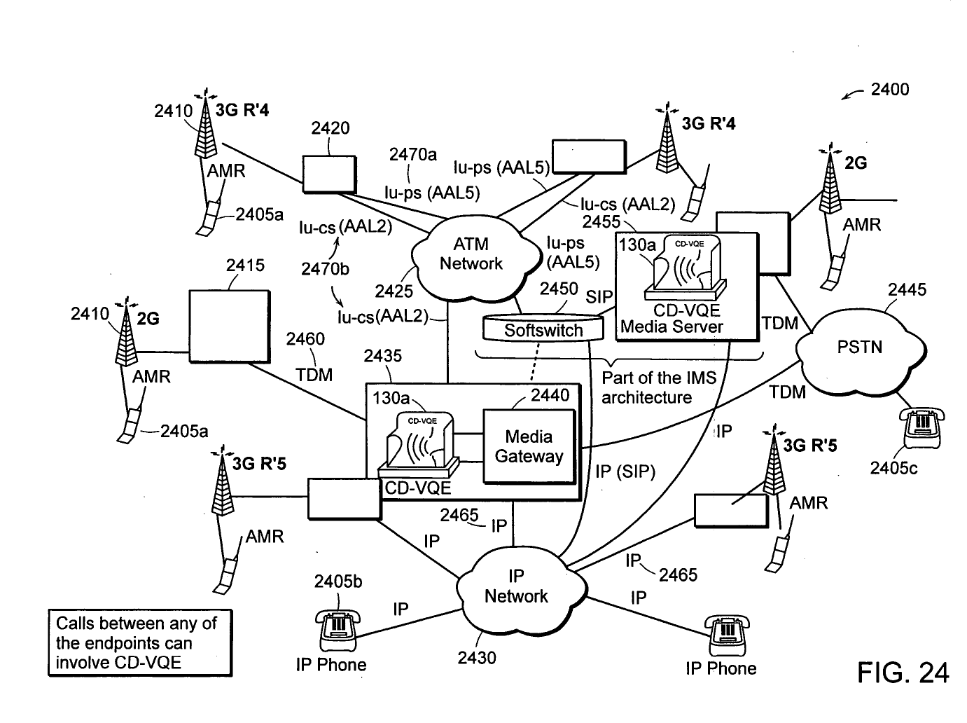

FIG. 24 is a network diagram of an example network 2400 in which the CD-VQE system 130a, or subsets thereof, are used in multiple locations such that calls between any endpoints, such as cell phones 2405a, IP phones 2405b, traditional wire line telephones 2405c, personal computers (not shown), and so forth can involve the CD-VQE process(ors) disclosed herein above. The network 2400 includes Second Generation (2G) network elements and Third Generation (3G) network elements, as well as Voice-over-IP (VoIP) network elements.

For example, in the case of a 2G network, the cell phone 2405a includes an adaptive multi-rate coder and transmits signals via a wireless interface to a cell tower 2410. The cell tower 2410 is connected to a base station system 2410, which may include a Base Station Controller (BSC) and Transmitter/Receiver Access Unit (TRAU). The base station system 2410 may use Time Division Multiplexing (TDM) signals 2460 to transmit the speech to a media gateway system 2435, which includes a media gateway 2440 and a CD-VQE system 130a.

The media gateway system 2435 in this example network 2400 is in communication with an Asynchronous Transfer Mode (ATM) network 2425, Public Switched Telephone Network (PSTN) 2445, and Internet Protocol (IP) network 2430. The media gateway system 2435, for example, converts the TDM signals 2460 received from a 2G network into signals appropriate for communicating with network nodes using the other protocols, such as IP signals 2465, Iu-cs(AAL2) signals 2470b, Iu-ps(AAL5) signals 2470a, and so forth. The media gateway system 2435 may also be in communication with a softswitch 2450, which communicates through a media server 2455 that includes a CD-VQE 130a.

It should be understood that the network 2400 may include various generations of networks, and various protocols within each of the generations, such as 3G-R′4 and 3G-R′5. As described above, the CD-VQE 130a, or subsets thereof may be deployed or associated with any of the network nodes that handle coded domain signals. Although endpoints (e.g., phones) in a 3G or 2G network can perform VQE, using the CD-VQE system 130a, within the network can improve VQE performance since endpoints have very limited computational resources compared with network based VQE systems. Therefore, more computational intensive VQE algorithms can be implemented on a network based VQE systems as compared to an endpoint. Also, battery life of the endpoints, such as the cellular telephone 2405a, can be enhanced because the amount of processing required by the processors described herein tends to use a lot of battery power. Thus, higher performance VQE will be attained by inner network deployment.

For example, the CD-VQE system 130a, or subsystems thereof, may be deployed in a media gateway, integrated with a base station at a Radio Network Controller (RNC), deployed in a session border controller, integrated with a router, integrated or alongside a transcoder, deployed in a wireless local loop (either standalone or integrated), integrated into a packet voice processor for Voice-over-Internet Protocol (VoIP) applications, or integrated into a coded domain transcoder. In VoIP applications, the CD-VQE may be deployed in an Integrated Multi-media Server (IMS) and conference bridge applications (e.g., a CD-VQE is supplied to each leg of a conference bridge) to improve announcements.

In a Local Area Network (LAN), the CD-VQE may be deployed in a small scale broadband router, Wireless Maximization (WiMax) system, Wireless Fidelity (WiFi) home base station, or within or adjacent to an enterprise gateway. Using exemplary embodiments of the present invention, the CD-VQE may be used to improve acoustic echo control or non-acoustic echo control, improve error concealment, or improve voice quality.

Although, described in reference to telecommunications services, it should be understood that the principles of the present invention extend beyond telecommunications and to other areas of telecommunications. For example, other exemplary embodiments of the present invention include wideband Adaptive Multi-Rate (AMR) applications, music with wideband AMR video enhancement, or pre-encode music to improve transport, to name a few.

Although described herein as being deployed within a network, other exemplary embodiments of the present invention may also be employed in handsets, VoIP phones, media terminals (e.g., media phone) VQE in mobile phones, or other user interface devices that have signals being communicated in a coded domain. Other areas may also benefit from the principles of the present invention, such as in the case of forcing Tandem Free Operations (TFO) in a 2G network after 3G-to-2G handoff has taken place or in a pure TFO in a 2G network or in a pure 3G network.

Other coded domain VQE applications include (1) improved voice quality inside a Real-time Session Manager (RSM) prior to handoff to Applications Servers (AS)/Media Gateways (MGW); (2) voice quality measurements inside a RSM to enforce Service Level Agreements (SLA's) between different VoIP carriers; (3) many of the VQE applications listed above can be embedded into the RSM for better voice quality enforcement across all carrier handoffs and voice application servers. The CD-VQE may also include applications associated with a multi-protocol session controller (MSC) which can be used to enforce Quality of Service (QoS) policies across a network edge.

It should be understood that the CD-VQE processors or related processors described herein may be implemented in hardware, firmware, software, or combinations thereof. In the case of software, machine-executable instructions may be stored locally on magnetic or optical media (e.g., CD-ROM), in Random Access Memory (RAM), Read-Only Memory (ROM), or other machine readable media. The machine executable instructions may also be stored remotely and downloaded via any suitable network communications paths. The machine-executable instructions are loaded and executed by a processor or multiple processors and applied as described hereinabove.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of modifying an encoded signal, comprising:
modifying at least one parameter of a first encoded signal resulting in a corresponding at least one modified parameter; and
replacing the at least one parameter of the first encoded signal with the at least one modified parameter resulting in a second encoded signal which, in a decoded state, approximates a target signal that is a function of the first encoded signal in at least a partially decoded state.

2. The method according to claim 1 wherein modifying the at least one parameter includes reducing noise in the first encoded signal in at least a partially decoded state in a linear domain to generate the target signal.

3. The method according to claim 1 further including computing a target scale factor that is a function of the target signal and at least the first encoded signal in at least a partially decoded state.

4. The method according to claim 3 wherein computing the target scale factor includes computing a square root of a ratio of energies of corresponding segments of the target signal and at least the first encoded signal in at least a partially decoded state or computing a median or average of the ratio of the absolute values of the samples of corresponding segments of the target signal and at least the first encoded signal in at least a partially decoded state.

5. The method according to claim 1 wherein modifying the at least one parameter includes modifying a fixed codebook gain parameter and an adaptive codebook gain parameter.

6. The method according to claim 1 wherein modifying the at least one parameter includes modifying at least one of the following parameters: fixed codebook gain parameter, adaptive codebook gain parameter, fixed codebook vector, pitch lag parameter, or Linear Predictive Coding (LPC) filter parameters.

7. The method according to claim 1 wherein the first and second encoded signals are Code Excited Linear Prediction (CELP) encoded signals.

8. The method according to claim 1 further including calculating an adaptive codebook gain.

9. The method according to claim 8 wherein calculating an adaptive codebook gain includes:
(i) computing a target scale factor that is a function of the target signal and at least the first encoded signal in at least a partially decoded state;
(ii) computing an adaptive codebook scale factor that is equal to the target scale factor multiplied by a square root of a ratio of (a) energy of an adaptive codebook vector corresponding to the first encoded signal to (b) energy of an adaptive codebook vector corresponding to the second codebook signal;
(iii) multiplying the adaptive codebook scale factor by an adaptive codebook gain resulting in a modified, adaptive codebook gain; and
(iv) quantizing the modified, adaptive codebook gain resulting in a quantized, modified, adaptive codebook, gain parameter; and
wherein replacing the at least one parameter includes replacing an adaptive codebook gain parameter in an encoded state with the quantized, modified, adaptive codebook, gain parameter.

10. The method according to claim 1 further including calculating a fixed codebook gain.

11. The method according to claim 10 wherein calculating a fixed codebook gain includes:
(i) computing a target scale factor that is a function of the target signal and at least the first encoded signal in at least a partially decoded state;
(ii) calculating roots of an equation obtained by equating (a) energy of excitation of the first encoded signal multiplied by the target scale factor squared to (b) energy of excitation of the second encoded signal;
(iii) (A) assigning a fixed codebook scale factor to the ratio of a value of a real, positive root of the equation, if it exists, to the fixed codebook gain parameter in a decoded state, or (B) assigning the fixed codebook scale factor to zero if it does not exist and (1) calculating an adaptive codebook scale factor to be the target scale factor multiplied by the square root of a ratio of (a) energy of excitation of the first encoded signal to (b) energy of the adaptive codebook vector of the second encoded signal, (2) multiplying the adaptive codebook scale factor by an adaptive codebook gain in a decoded state resulting in a modified, adaptive codebook gain, and (3) quantizing the modified, adaptive codebook gain resulting in a quantized, modified, adaptive codebook, gain parameter;
(iv) multiplying the fixed codebook scale factor by a fixed codebook gain parameter in a decoded state resulting in a modified, fixed codebook gain;
(v) quantizing the modified, fixed codebook gain resulting in a quantized, modified, fixed codebook, gain parameter; and
wherein replacing the at least one parameter includes (a) replacing a fixed codebook gain parameter in an encoded state with the quantized, modified, fixed codebook, gain parameter, and, if a value of a real positive root of the equation does not exist, (b) replacing an adaptive codebook gain parameter in an encoded state with the quantized, modified, adaptive codebook, gain parameter.

12. The method according to claim 1 wherein modifying the at least one parameter includes modifying an adaptive codebook gain parameter, fixed codebook gain parameter, and fixed codebook vector by encoding the adaptive codebook gain parameter, fixed codebook gain parameter, and fixed codebook vector while keeping a pitch lag parameter and Linear Predictive Coding (LPC) filter parameters unmodified.

13. The method according to claim 12 wherein the encoding is CELP encoding.

14. The method according to claim 1 further including:
comparing a metric of the first encoded signal in at least a partially decoded state against a threshold;
if the metric is above the threshold, the method further includes modifying the adaptive codebook gain parameter and the fixed codebook gain parameter; and
if the metric is below the threshold, the method further includes modifying an adaptive codebook gain parameter, fixed codebook gain parameter, and fixed codebook vector.

15. The method according to claim 1 used for voice quality enhancement.

16. An apparatus for modifying an encoded signal, comprising:
a decoder partially decoding a first encoded signal into a corresponding linear domain signal in at least a partially decoded state and decoding at least one encoded parameter of the first encoded signal resulting in a corresponding at least one parameter in a decoded state;
a linear domain processor generating a target signal as a function of the first encoded signal in the at least partially decoded state; and
a coded domain processor (i) modifying the at least one parameter in a decoded state resulting in a corresponding at least one modified parameter and (ii) replacing the at least one encoded parameter of the first encoded signal with the at least one modified parameter in an encoded state resulting in a second encoded signal, which, when decoded, approximates the target signal.

17. The method according to claim 16 wherein the coded domain processor includes a noise reduction unit that reduces noise in the first encoded signal in at least a partially decoded state in a linear domain to generate the target signal.

18. The apparatus according to claim 16 wherein the coded domain processor includes a scale computation unit that calculates a target scale factor as a function of the target signal and at least the first encoded signal in a partially decoded state.

19. The apparatus according to claim 18 wherein the scale computation unit calculates the target scale factor by computing a square root of a ratio of energies of corresponding segments of the target signal and at least the first encoded signal in at least a partially decoded state or computing a median or average of the ratio of the absolute values of the samples of corresponding segments of the target signal and at least the first encoded signal in at least a partially decoded state.

20. The apparatus according to claim 16 wherein the at least one modified parameter includes a fixed codebook gain parameter and an adaptive codebook gain parameter.

21. The apparatus according to claim 16 wherein the at least one modified parameter includes at least one of the following parameters: fixed codebook gain parameter, adaptive codebook gain parameter, fixed codebook vector, pitch lag parameter, or Linear Predictive Coding (LPC) filter parameters.

22. The apparatus according to claim 16 wherein the encoded signal is a Code Excited Linear Prediction (CELP) encoded signal.

23. The apparatus according to claim 16 wherein the decoder is a first decoder and wherein the second processor further includes:
a scale computation unit that calculates a target scale factor as a function of the target signal and at least the first encoded signal in a partially decoded state;
a second decoder at least partially decoding the second encoded signal and outputting at least an adaptive codebook vector; and
a coded domain parameter modification unit that computes the at least one modified parameter as a function of the target scale factor, at least one decoded parameter, at least adaptive codebook vector, and at least one modified parameter.

24. The apparatus according to claim 16 wherein the coded domain processor calculates an adaptive codebook gain.

25. The apparatus according to claim 24 wherein, to calculate the adaptive codebook gain, the coded domain processor:
(i) computes a target scale factor that is a function of the target signal and at least the first encoded signal in at least a partially decoded state;
(ii) computes an adaptive codebook scale factor that is equal to the target scale factor multiplied by a square root of a ratio of (a) energy of an adaptive codebook vector corresponding to the first encoded signal to (b) energy of an adaptive codebook vector corresponding to the second codebook signal;
(iii) multiplies the adaptive codebook scale factor by an adaptive codebook gain resulting in a modified, adaptive codebook gain;
(iv) quantizes the modified adaptive codebook gain resulting in a quantized, modified, adaptive codebook, gain parameter; and
(v) replaces an adaptive codebook, gain parameter in an encoded state with the quantized, modified, adaptive codebook, gain parameter.

26. The apparatus according to claim 16 wherein the coded domain processor calculates a fixed codebook gain.

27. The apparatus according to claim 26 wherein to calculate the fixed codebook gain, the coded domain processor:
(i) computes a target scale factor that is a function of the target signal and at least the first encoded signal in at least a partially decoded state;
(ii) calculates roots of an equation obtained by equating (a) energy of excitation of the first encoded signal multiplied by the target scale factor squared to (b) energy of excitation of the second encoded signal;
(iii) assigns a fixed codebook scale factor to the ratio of a value of a real, positive root of the equation, if it exists, to the fixed codebook gain parameter in a decoded state, or assigns the fixed codebook scale factor to zero if it does not exist and (a) calculates an adaptive codebook scale factor to be the target scale factor multiplied by the square root of a ratio of (1) energy of excitation of the first encoded signal to (2) energy of the adaptive codebook vector of the second encoded signal, (b) multiplies the adaptive codebook scale factor by an adaptive codebook gain resulting in a modified, adaptive codebook gain, and (c) quantizes the modified, adaptive codebook, gain resulting in a quantized, modified, adaptive codebook, gain parameter;
(iv) multiplies the fixed codebook scale factor by a fixed codebook gain parameter in a decoded state resulting in a modified, fixed, codebook gain;
(v) quantizes the modified, fixed codebook gain resulting in a quantized, modified, fixed codebook, gain parameter; and
(vi) (a) replaces a fixed codebook gain parameter in an encoded state with the quantized, modified, fixed codebook, gain parameter, and, if a value of a real positive root of the equation does not exist, (b) replaces an adaptive codebook gain parameter in an encoded state with the quantized, modified, adaptive codebook, gain parameter.

28. The apparatus according to claim 16 wherein the coded domain processor includes an encoder and modifies an adaptive codebook gain parameter, fixed codebook gain parameter, and fixed codebook vector by using the encoder to encode the adaptive codebook gain parameter, fixed codebook gain parameter, and fixed codebook vector while keeping a pitch lag parameter and Linear Predictive Coding (LPC) filter parameters unmodified.

29. The apparatus according to claim 28 wherein the encoder is CELP encoder.

30. The apparatus according to claim 16 further including:
a comparator comparing a metric of the first encoded signal in at least a partially decoded state against a threshold;
if the metric is above the threshold, the second processor modifies the adaptive codebook gain parameter and the fixed codebook gain parameter; and
if the metric is below the threshold, the second processor modifies an adaptive codebook gain parameter, fixed codebook gain parameter, and fixed codebook vector.

31. The apparatus according to claim 16 operating as an echo suppressor, noise reducer, adaptive level controller, or adaptive signal gain controller.

32. The apparatus according to claim 16 used in a voice quality enhancer.

33. The apparatus according to claim 16 implemented in at least one of the following forms: software executed by a processor, firmware, or hardware.
